(19) United States
(12) Patent Application Publication
(10) Pub. No.: US 2024/0190707 A1
(43) Pub. Date: Jun. 13, 2024

(54) HIGHLY MICROPOROUS LASER-FABRICATED GRAPHENE

(71) Applicant: George Mason University, Fairfax, VA (US)

(72) Inventors: Pilgyu Kang, Fairfax, VA (US); Shirin Movaghgharnezhad, Fairfax, VA (US); Minsu Kim, Daejeon (KR); Byoung Gak Kim, Daejeon (KR)

(21) Appl. No.: 18/520,858

(22) Filed: Nov. 28, 2023

Related U.S. Application Data
(60) Provisional application No. 63/428,288, filed on Nov. 28, 2022.

(51) Int. Cl. C01B 32/184

(52) U.S. Cl. CPC C01B 32/184; C01B 2204/04; C01B 2204/32

(57) ABSTRACT

Highly microporous laser fabricated three-dimensional graphene which can be prepared from a fluorinated polyimide is disclosed. The three-dimensional porous graphene may have a multi-scale structure, which enables optimum photodetection, particularly across the visible wavelengths, and other improved optical properties. In some aspects, the porous graphene has the following pore structure: macropores having an average pore size exceeding 50 nm; mesopores having an average pore size of 2-50 nm; micropores having an average pore size of 2 nm or less; and nanopores having an average pore size of less than 100 nm. A broadband, high-sensitivity photodetector based on three-dimensional (3D) porous graphene is also disclosed. The 3D porous graphene may be derived from a fluorinated polyimide, via for example a laser photothermal method. The porous graphene exhibits an ultrahigh specific surface area, facilitating optical-absorption properties, such as light-absorbing area and optical resonance.

### CROSS-REFERENCE TO RELATED APPLICATIONS

This application claims priority to U.S. Provisional Application No. 63/428,288, filed Nov. 28, 2022, which is incorporated into this application by reference.

### BACKGROUND

Graphene-based nanomaterials with zero bandgap have outstanding properties including mechanical flexibility, high carrier mobility, broadband light absorption, and high electrical conductivity. Due to these exceptional properties, graphene-based nanomaterials have a potential to be used as optical materials in photonics and optoelectronics applications, such as photodetectors, light-emitting devices, solar cells, and wearable optoelectronic devices for health monitoring and image sensing. However, the low optical absorption of monolayer graphene (˜2.3%), attributed to its one-atom-thick structure, has limited the practical application of graphene to optoelectronics. Numerous approaches have demonstrated optical absorption enhancement of graphene by combining graphene with optical structures such as plasmonic nanostructures, optical waveguides, and microcavities. However, these structures restrict broadband photodetection.

Optical absorption enhancement of graphene has also been achieved by constructing vertical heterostructures containing graphene and other two-dimensional (2D) atomic layers such as InSe and MoS₂ or by integrating various nanomaterials including perovskites and quantum dots. However, these approaches rely on hybrid materials, which form heterogeneous interfaces with graphene and consequently lower the carrier mobility. In addition to limiting the broadband absorption or reducing the carrier mobility, hybrid approaches require complicated and expensive manufacturing processes. The light-absorbing area can be increased by nanostructuring 2D graphene into three-dimensional (3D) graphene structures, which would lead to photoresponsivity enhancement. However, synthesizing graphene as a light-sensitive functional material and constructing 3D structures increase the manufacturing time and costs; moreover, the 3D nanostructuring requires multiple fabrication processes. Thus, it is highly desirable to devise a facile, cost- and time-effective fabrication technique to achieve optical absorption enhancement and, consequently, photoresponsivity enhancement along with broadband photodetection, which would help realize the practical application of graphene-based photodetectors.

Silicon was shaped with porous structures for optical absorption in a broad wavelength range of 400-1,075 nm and high-sensitivity photodetection. The high sensitivity is attributed to the micro- and mesoporous silicon structures, which increase the specific surface area and thus the optical absorption. Micro- and mesoporous structures influence the optical properties of the material; they facilitate not only a high light-absorbing area but also light capturing/trapping by the pore-shaped structures, thereby minimizing light reflection and scattering. 3D porous graphene (3DPG) with open and interconnected pores generated by transient laser photothermal processing allows for mechanical flexibility, high electrical conductivity, and a large specific surface area. Owing to these properties, laser-generated 3DPG has been explored as a multifunctional material for a wide range of applications such as micro-supercapacitors, electrochemical sensors, monolithic bilayer membranes for solar desalination, and air filters. The high specific surface area, which originates from the heterogeneous porous structures of laser-induced graphene, significantly enhances the power density, electrochemical sensitivity, and solar desalination efficiency. However, micro- and nanoscopic structural effects of the laser-induced graphene on optical properties (e.g., light absorption) and photoresponse have not been sufficiently addressed in the art.

### SUMMARY

Graphene has potential in optoelectronic applications owing to its high broadband light absorption. Various approaches have overcome the intrinsic low optical absorption of graphene but the low broadband capability limits its wide-range applicability. This application describes a broadband, high-sensitivity photodetector based on three-dimensional (3D) porous graphene derived from a fluorinated polyimide, via for example a laser photothermal method. The porous graphene exhibits an ultrahigh specific surface area, facilitating optical-absorption properties, such as light-absorbing area and optical resonance.

The disclosed porous graphene may have a multi-scale structure, for example, the porous graphene may include one or more of the following pore structures: a) macropores having an average pore size exceeding 50 nm; b) mesopores having an average pore size of 2-50 nm; c) micropores having an average pore size of 2 nm or less; and d) nanopores having an average pore size of less than 100 nm. The nanopore structures may in some aspects have a BET specific surface area of at least 300 m²/g.

Also described is a method for making a porous graphene film, which may include irradiating a film of a fluorinated polyimide which has at least one aromatic ring with an infrared laser under conditions sufficient to form the porous graphene film.

Also described are photodetectors and other devices that comprise the porous graphene, as well as methods of making the photodetectors and devices, in addition to applications of the photodetectors and devices.

### BRIEF DESCRIPTION OF THE DRAWINGS

FIG. 1A shows a diagram depicting 3D-porous-graphene (“PG”)-based photodetector devices and heterogeneous multiscale pore structures of 3DPG based on a fluorinated polyimide-based highly microporous graphene (“fPI-3DPG”). The chemical structure of the fPI used is shown in the inset.

FIG. 1B shows a diagram depicting 3D-porous-graphene (“PG”)-based photodetector devices and heterogeneous multiscale pore structures of 3DPG based on a non-fluorinated polyimide-based porous graphene (“PI-3DPG”). The chemical structures of the PI used is shown in the inset.

FIG. 2A is an SEM image showing macroscale porous structures (Dₚₒᵣₑ>1.5 μm) for fPI-3DPG.

FIG. 2B is an SEM image showing heterogeneous micro- and mesopore structures (Dₚₒᵣₑ>0.5 nm) for fPI-3DPG.

FIG. 2C shows a Raman spectra of fPI-3DPG generated at laser powers of 1.65, 1.8, and 1.95 W and a spectrum for a plain fPI film.

FIG. 2D is a plot showing pore size distributions of fPI-3DPG and PI-3DPG. fPI-3DPG showed a Horvath-Kawazoe pore volume of 0.511 cm³/g, and a median pore width of 0.792 nm, whereas PI-3DPG showed a Horvath-Kawazoe pore volume of 0.105 cm³/g, and a median pore width of 0.769 nm.

FIG. 2E is a plot showing Ar adsorption-desorption isotherms of fPI-3DPG and PI-3DPG. The analysis (BET surface area) plotted only accounts for porous structures with Dₚₒᵣₑ<100 nm. The BET surface area for the fPI-3DPG was found to be 1309.7 m²/g, whereas the BET surface area for the PI-3DPG was found to be 272.8 m²/g.

FIG. 3A shows the extinction of the fPI-3DPG photodetector in comparison to that of the PI-3DPG photodetector. The inset shows the extinction of the fPI-3DPG photodetector compared to that of flat graphene photodetector in the visible wavelength range 448-638 nm.

FIG. 3B is a schematic of a physical mechanism of photoresponsivity enhancement due to the resonant heterogeneous multiscale pores via trapping and light scattering of incident photons in the interconnected pores.

FIG. 3C is a plot of photoresponsivity with the incident laser power at V_{bias}=0.1 V at λ_{light}=448 nm (top), 519 nm (bottom), and 638 nm (middle).

FIG. 3D is a plot of photocurrent variations with the incident laser power at V_{bias}=0.1 V at λ_{light}=448 nm (top), 519 nm (bottom), and 638 nm (middle).

FIG. 3E is a plot showing dynamic photoresponse of fPI-3DPG photodetectors for various illumination intensities ranging 0.5-5 mW, with mW increasing with increasing photocurrent, i.e., 5 mW represents the top most curve, and 0. mW the bottom most curve, at λ_{light}=448 nm and V_{bias}=0.1 V.

FIG. 3F includes plots showing the comparison of the photoresponsivities of fPI-3DPG (top) and PI-3DPG photodetectors (bottom).

FIG. 4A shows photocurrent measurements at various bending strains ranging 0.5%-1.1%, measured with the described devices. The inset shows a photograph of the device at 0.7% bending strain.

FIG. 4B shows photocurrent measurements at various twisting angles from −90° to +90°. The inset shows a photograph of the PD device at 45° twisting angle.

FIG. 4C shows photocurrent measurements at various bending cycles up to 10,000. The inset shows a photograph of the device at 0% and 1.1% bending strains.

FIG. 4D shows photocurrent measurements at various twisting cycles up to 10,000. The inset shows a photograph of the device at 0° and 90° twisting angles.

FIG. 5A shows photographs of fPI-3DPG photodetector arrays with nine sensing channels, eighteen contact pads, and interconnects. The inset on the right shows an optical microscopy image of the porous graphene PD channels.

FIG. 5B shows the dynamic photoresponse of the fPI-3DPG PD array devices (3×3 arrays), as depicted in FIG. 5A, at λ_{light}=448 nm.

FIG. 5C shows optical light intensity measurements of laser incident on the fPI-3DPG PD array devices.

FIG. 5D shows conformal fPI-3DPG microelectrode arrays (MEAs) on the surface of a human brain model.

FIG. 5E shows a photograph of a conformal fPI-3DPG photodetector integrated on a contact lens placed on a human eye model. The inset on the right is an enlarged view of the integrated fPI-3DPG PD on the contact lens.

FIG. 5F shows the dynamic photoresponse of the fPI-3DPG on the contact lens for an illumination power of 5 mW by 448 nm laser light, measured for three on-off cycles.

FIG. 6A shows scanning electron microscopy (SEM) image showing cross-sections of fPI-3DPG. The thicknesses of the fPI-3DPG from SEM images are ˜70 μm.

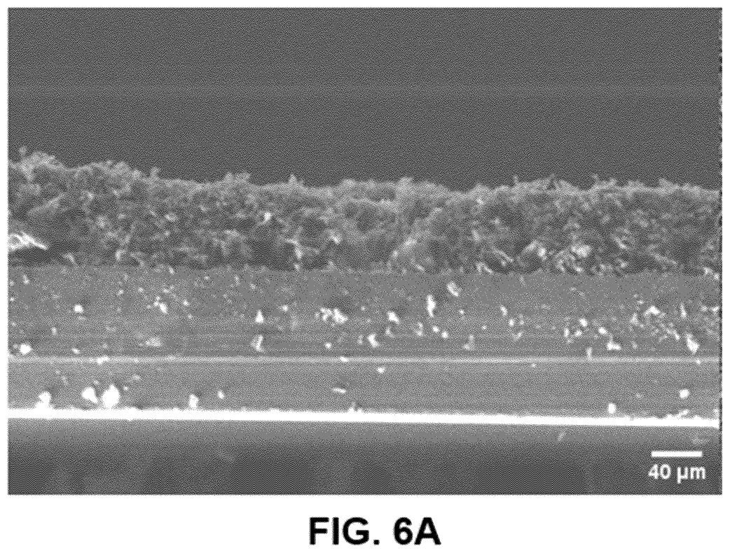

FIG. 6B shows a scanning electron microscopy (SEM) image showing cross-sections of PI-3DPG. The thicknesses of the PI-3DPG from SEM images are ˜68 μm.

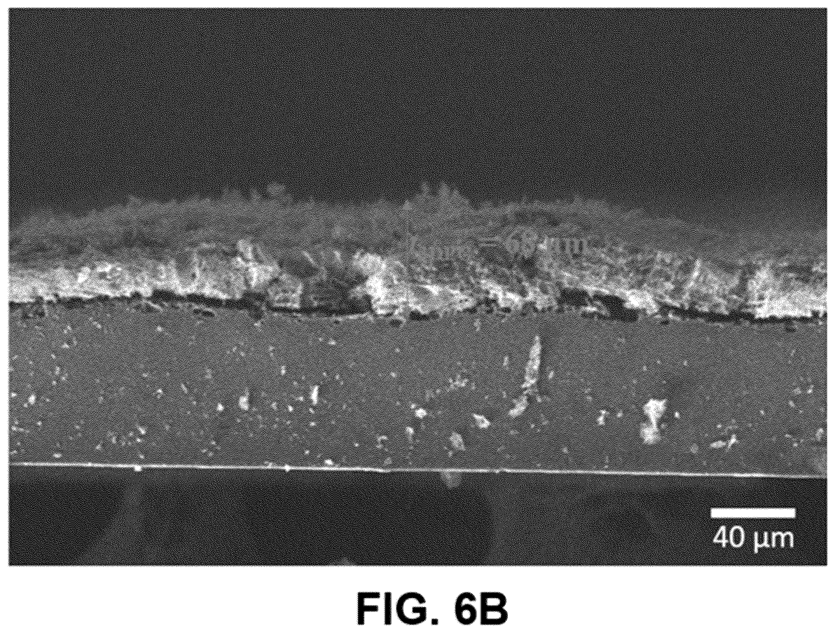

FIG. 7 shows tunneling electron microscope (TEM) images of fPI-3DPG showing the lattice structure of porous graphene. The spaces between the layers of graphene in fPI-3DPG are in a range of 0.36-0.41 nm.

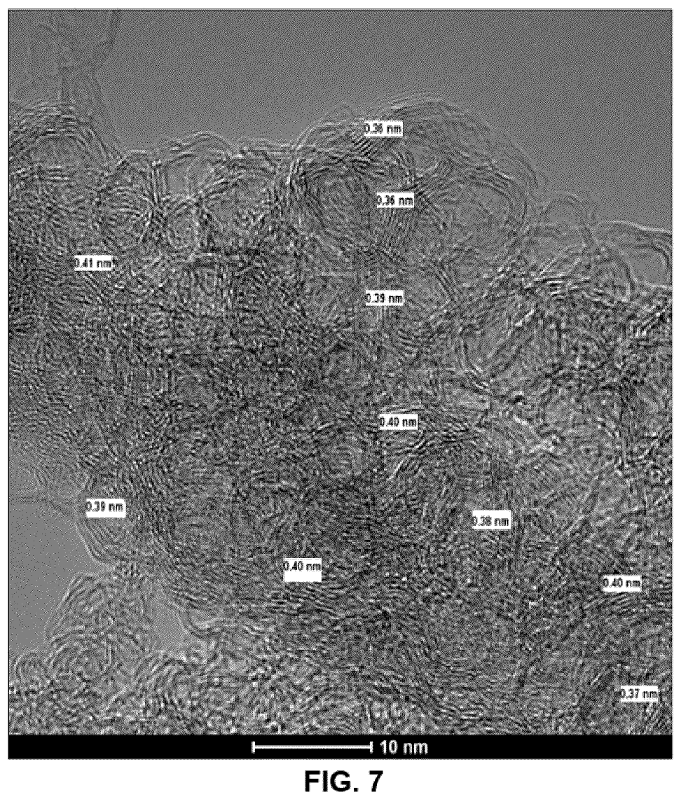

FIG. 8 shows X-ray diffraction (XRD) spectra of the fPI-3DPG structures. The peak at 2θ=21.5° to 25.8° and 43.5° indicate (002) plane and (100) plane reflection in fPI-3DPG, respectively.

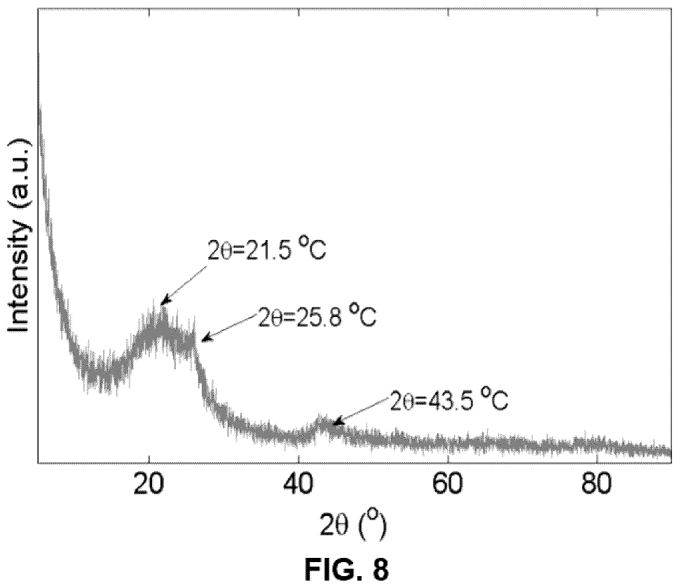

FIG. 9A shows X-ray photoelectron spectroscopy (XPS) spectra of the PI-3DPG and fPI-3DPG with peak fitting for C1 peaks.

FIG. 9B shows X-ray photoelectron spectroscopy (XPS) spectra of the PI-3DPG and fPI-3DPG with peak fitting for C1 peaks.

FIG. 9C shows X-ray photoelectron spectroscopy (XPS) spectra of the PI-3DPG and fPI-3DPG with peak fitting for F1 peaks.

FIG. 9D shows X-ray photoelectron spectroscopy (XPS) spectra of the PI-3DPG and fPI-3DPG with peak fitting for F1 peaks.

FIG. 9E shows X-ray photoelectron spectroscopy (XPS) spectra of the PI-3DPG and fPI-3DPG with peak fitting for O1 peaks.

FIG. 9F shows X-ray photoelectron spectroscopy (XPS) spectra of the PI-3DPG and fPI-3DPG with peak fitting for O1 peaks.

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

### DETAILED DESCRIPTION

### I. Three-Dimensional Microporous Graphene

As briefly described above, the disclosed three-dimensional porous graphene may have a multi-scale structure, which enables good photodetection, particularly across the visible wavelengths, and other improved optical properties. In some aspects, the porous graphene may have a structure including one or more of the following pore structures: macropores having an average pore size exceeding 50 nm; mesopores having an average pore size of 2-50 nm; micropores having an average pore size of 2 nm or less; and nanopores having an average pore size of less than 100 nm.

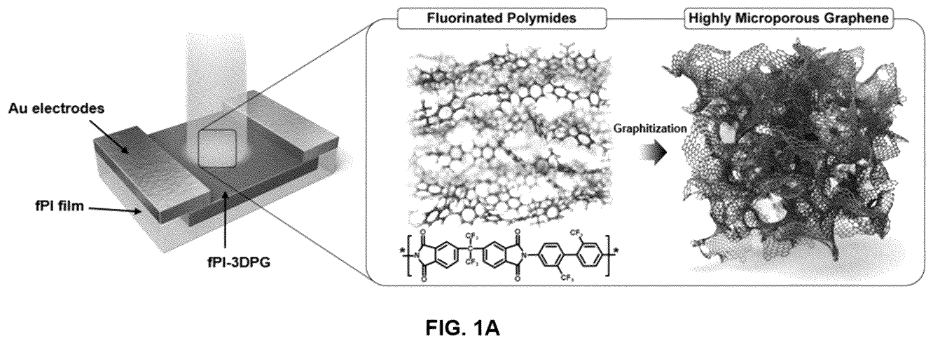

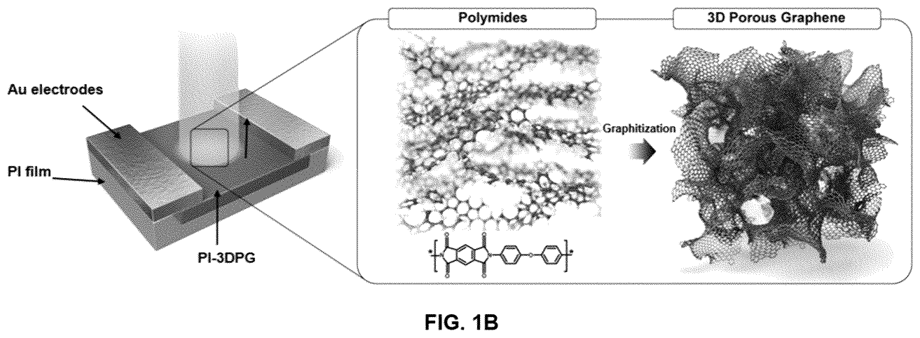

The disclosed 3D porous graphene (3DPG) is formed from flourinated polymides as described hereinafter and may be referred to as fluorinated polyimide-based highly microporous graphene (“fPI-3DPG”). FIG. 1A shows a diagram depicting 3D-porous-graphene (3DPG) based photodetector devices and heterogeneous multiscale pore structures of 3DPG based on a fluorinated polyimide-based highly microporous graphene (“fPI-3DPG”). The chemical structure of the fPI (fluorinated polymides) used is shown in the inset. In this disclosure, the properties and physical characteristics of fPI-3DPG are often compared with the properties and physical chatacteristics of 3DPG based on a non-fluorinated polyimide-based porous graphene (“PI-3DPG”). FIG. 1B shows a diagram depicting 3D-porous-graphene (“PG”)-based photodetector devices and heterogeneous multiscale pore structures of 3DPG based on a non-fluorinated polyimide-based porous graphene (“PI-3DPG”). The chemical structures of the PI (Polymides) used is shown in the inset.

The nanopores of the fPI-3DPG in some aspects can provide for a high or even ultra high specific surface area, measured by the BET method which is known in the art. In some aspects, the nanopores of the porous graphene have a BET specific surface area of at least 300 m²/g. In a further aspect, the nanopores of the fPI-3DPG have a BET specific surface area of at least 400 m²/g. In a further aspect, the nanopores of the fPI-3DPG have a BET specific surface area of at least 500 m²/g. In a further aspect, the nanopores of the fPI-3DPG have a BET specific surface area of at least 600 m²/g. In a further aspect, the nanopores of the fPI-3DPG have a BET specific surface area of at least 700 m²/g. In a further aspect, the nanopores of the fPI-3DPG have a BET specific surface area of at least 800 m²/g. In a further aspect, the nanopores of the fPI-3DPG have a BET specific surface area of at least 900 m²/g. In a further aspect, the nanopores of the fPI-3DPG have a BET specific surface area of at least 1,000 m²/g. In a further aspect, the nanopores of the fPI-3DPG have a BET specific surface area of at least 1,200 m²/g. The upper limit for any of these threshold BET specific surface areas can vary, for example, 1,500 m²/g or in some aspects, 1,400 m²/g. In one aspect, the nanopores of the fPI-3DPG have a BET specific surface area of about 1,310 m²/g, “about” in this instance implying plus or minus 10 m²/g.

In a further aspect, the fPI-3DPG exhibits a Horvath-Kawazoe pore volume of at least 0.2 cm³/g. For example, the fPI-3DPG can exhibit a Horvath-Kawazoe pore volume of at least 0.25 cm³/g, at least 0.3 cm³/g, at least 0.35 cm³/g, at least 0.4 cm³/g, or at least 0.5 cm³/g. The upper limit for any of these pore volumes can vary, e.g., 0.8 cm³/g, 0.7 cm³/g, 0.6 cm³/g, or 0.55 cm³/g.

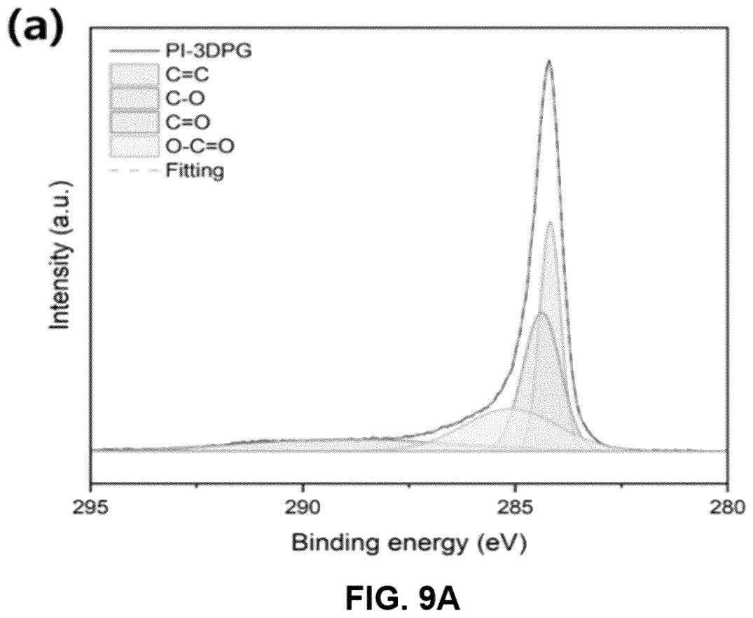

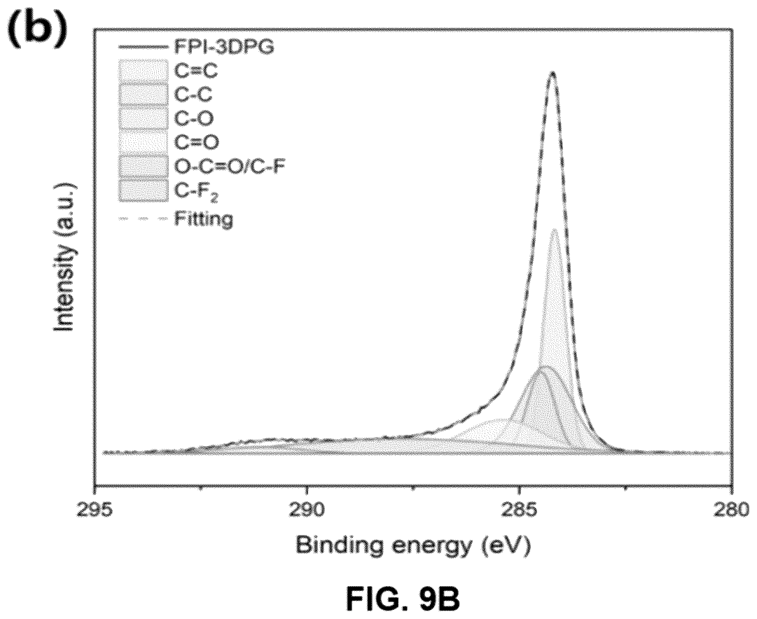

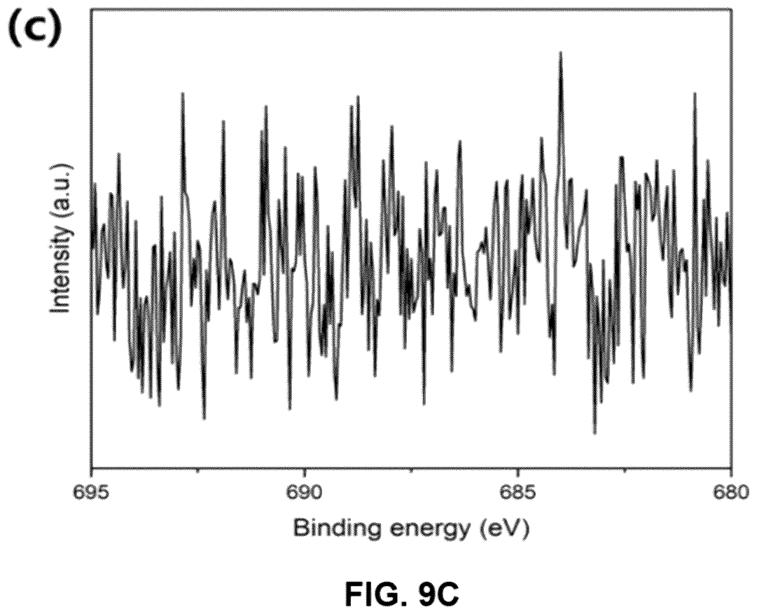

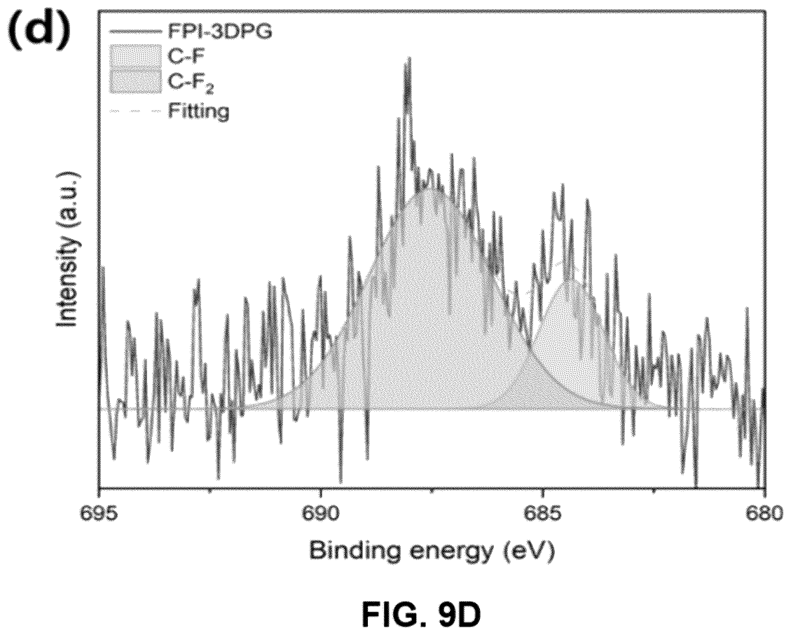

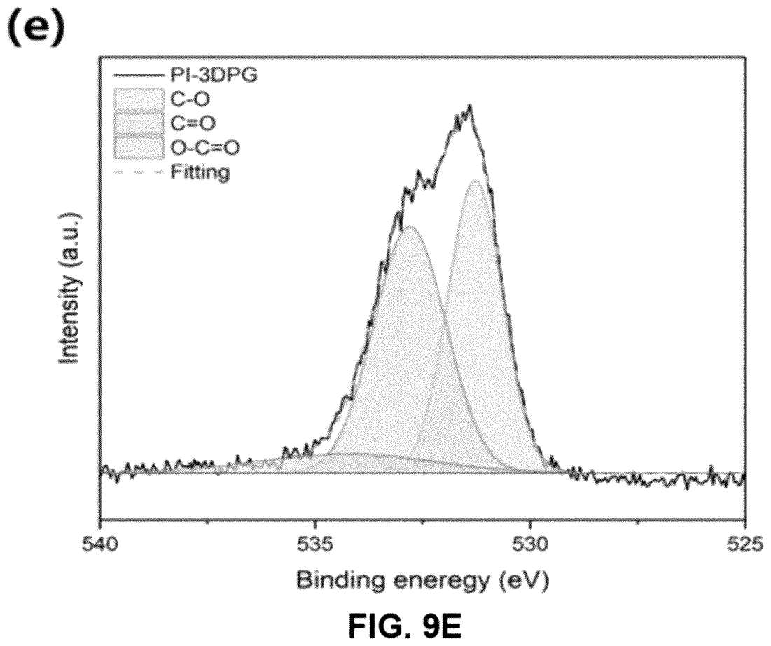

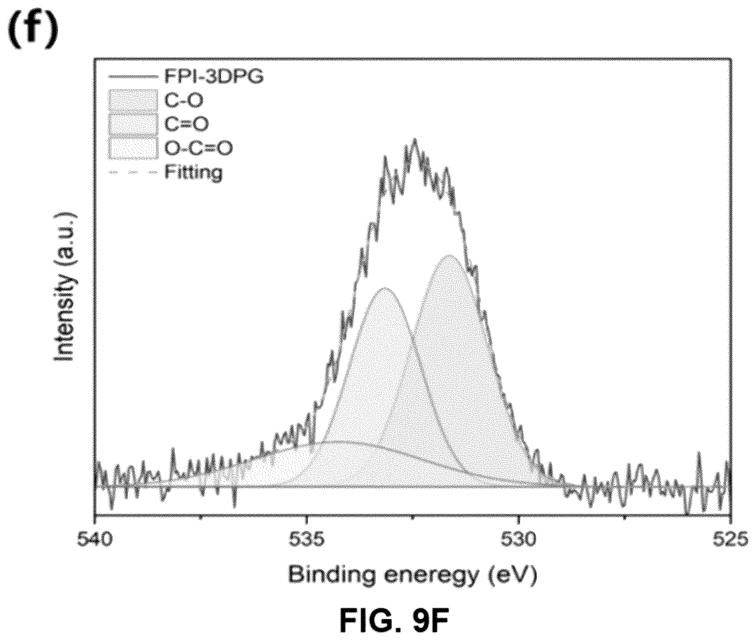

The described fPI-3DPG exhibits a high degree of graphitization as is evident from a number of characteristics. In one aspect, the porous graphene has a mean graphene interlayer spacing of 0.35-0.45 nm. In one specific embodiment, the interlayer spacing of the graphene is 0.39 nm. In some aspects the fPI-3DPG may include flourine atoms as a result of one exemplary method of making the fPI-3DPG described hereinbelow which uses fluorinated polymides as a precursor (e.g. graphitization is performed on fluorinated polymides). The flourine atoms may be disposed in the graphene sheets of the fPI-3DPG as the one shown in FIG. 1A. The flourine atoms may form C—F bonds and/or C—F₂ bonds in the 3DPG. For example, FIGS. 9 (a)-(c) show results of XPS experiments performed on PI-3DPG and FIG. 9 (d)-(f) show results of XPS experiments fPI-3DPG. The XPS results for fPI-3DPG (especially FIGS. 9(d)-(e)) show the presence of C—F bonds and/or C—F₂.

Thus, in one aspect, a disclosed embodiment of the 3D porous graphene may have a structure including one or more of the following pore structures: macropores having an average pore size exceeding 50 nm; mesopores having an average pore size of 2-50 nm; micropores having an average pore size of 2 nm or less; and nanopores having an average pore size of less than 100 nm. In addition, this embodiment may have a BET specific surface area of at least 300 m²/g, or any of the BET surface areas described above. Further, this embodiment may include fluorine in the graphene, for example, fluorine disposed in individual sheets of the graphene and/or covalently bound to one or more carbon atoms of the graphene, e.g., comprising a C—F or C—F₂ bond).

### II. Method of Making the 3D Porous Graphene Such as fPI-3DPG

Although the above-described graphene is not limited in scope to any particular production method, various multi-scale and porosity properties were surprisingly determined to be influenced by a method of manufacture. In some aspects, the porous graphene can be prepared by graphitizing a film of a fluorinated polyimide which has at least one aromatic ring. During graphitization, discharge of fluorine-based gas products, in addition to other gaseous products, was surprisingly discovered to result in a multi-scaled porous structure that is particularly amenable for optical applications such as photodetectors.

In some aspects, the method allows for the construction of patterned or array style devices by graphitizing an already-filmed precursor polymer on demand, depending on the desired application. In one aspect, graphitizing comprises irradiating the film with an infrared laser or other suitable types of lasers.

The fluorinated polyimide is not limiting provided it is capable of being graphitized, generally meaning it will have at least one aromatic ring, and provided it has at least one fluorine groups. As discussed above, at least part of the fluorine will be released during graphitization to provide for unique porous structures and in turn optical properties.

Non-limiting examples of such fluorinated polyimides include those having one of the following repeating units:

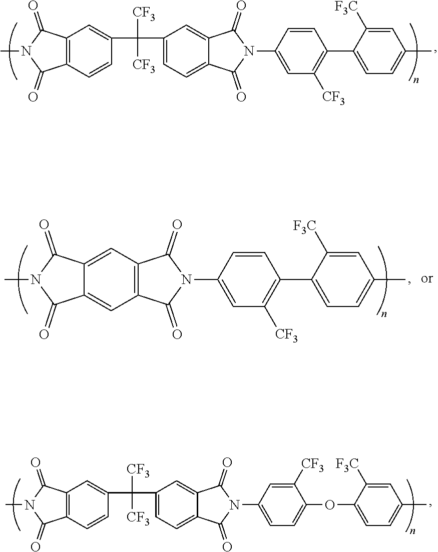

where each instance of n is independently an integer that is at least two. A variety of molecular weights beyond dimers are contemplated, typically only limited by the ability in some aspects to spin coat or otherwise solution coat the polyimide or a precursor thereof onto a substrate for imidization or graphitization. In one aspect, for example, the film of the fluorinated polyimide is prepared by thermal imidization of a precursor polyamic acid film.

Any suitable polyimide film thickness is contemplated, which in general will result in a film or graphene material of less thickness due to combustion of organic and other material, as well as organization of the graphene layers. In one aspect, the film of the fluorinated polyimide has an average thickness of 20-300 μm. A resulting graphene product or film can in some aspects have an average thickness of 10-180 μm.

Graphitization of the fluorinated polyimide can be accomplished through a variety of contemplated methods. One example is laser irradiation of the fluorinated polyimide. For example, irradiating can be performed with a CO₂ infrared laser, e.g., having a wavelength (λ) of 10.6 μm. In a specific aspect, irradiating can be performed at 1-2 Watts, 1,000 laser pulses per inch (PPI), and at a speed of 3-4 inches per second, for example with a CO₂ infrared laser, e.g., having a wavelength (λ) of 10.6 μm.

### III. Devices

Due in part to the disclosed fPI-3DPG graphene's unique porous structures, a variety of devices such as photodetectors can incorporate the 3D porous graphene (e.g. fPI-3DPG). In one aspect, it is contemplated that a photodetector can comprise the porous graphene of the graphene film prepared by the disclosed method (e.g. the fPI-3DPG). Photodetectors prepared from the graphene were observed to have excellent properties. For instance, in one aspect, the photodetectors exhibit broadband photodetection in the visible-light wavelength range with a high photoresponsivity, e.g., of 4.4 mA W⁻¹, an ultrahigh signal-to-noise ratio of (e.g., ˜208), and an excellent noise equivalent power (e.g., of 0.54×10⁻¹¹ W Hz^{-1/2}).

In addition, the disclosed materials, when incorporated into photodetectors and other devices, demonstrate excellent mechanical flexibility and reliability, e.g., as demonstrated under 10,000 cycles of bending and twisting. It is therefore contemplated that a photodetector can be integrated into a wearable or implantable device, which can be applied to living subject such as a pet or a human. A variety of applications including sensing and energy harvesting are contemplated.

Moreover, the disclosed laser photothermal method enables the synthesis of functional materials and direct device fabrication. For example, a precursor fluorinated polyimide can be directly graphitized on a substrate or in a device and rapidly used for optical imaging and spectroscopy applications.

### IV. Examples

The following examples further illustrate this disclosure. The scope of the disclosure and claims is not limited by the scope of the following examples.

### A. Fabrication of 3DPG from fPI and PI

A 10.6 μm CO₂ laser-cutter system (Universal, VLS2.30) was used for fabricating fluorinated polyimide 3D porous graphene (“fPI-3DPG”) and polyimide porous graphene (“PI-3DPG”) at laser powers of 1.65 and 4.8 W, respectively. The pulse duration and scan speed were fixed at ˜14 μs, and 3.5 in s⁻¹, respectively, and the laser treatment was performed under ambient conditions. It is understood that other laser types, wavelengths, laser powers, and pulse sequences may be used to fabricate the 3D porous graphene.

### B. Photoresponse Characterization

To characterize the photoresponse of the fPI-3DPG and PI-3DPG photodetectors, the photocurrents from three diode lasers with wavelengths of 448, 519, and 638 nm (laser power ranging 0.5-5 mW, through a 4× objective lens) were measured using a sourcemeter (2614B, Keithley Instruments) and microprobe station. I-V measurements were conducted across the device using the sourcemeter and microprobe station. In all experiments, the laser power and beam focus through the 4× objective lens were calibrated using a photodiode power sensor (Thorlabs, ITC4001).

### C. Fluorinated Polyimide Film Fabrication

A method for fabricating a Fluorinated polyimide film is disclosed. In an exemplary method, 0.1 mol of 2,2′-bis(trifluoromethyl)-[1,1′-biphenyl]-4,4′-diamine (TFB) was dissolved in 326 ml of anhydrous N,N-Dimethylacetamide (DMAc) in a 1-liter, 3-neck flat bottom type reaction flask equipped with a mechanical stirrer. The flask was placed in an ice bath under a nitrogen atmosphere, and 0.1 mol of 4,4′-(hexafluoroisopropylidene) diphthalic anhydride was added to the solution and mixed for one hour. Then, the mixture was stirred for 8 hours at room temperature. After the reaction, a 20 wt % poly(amic) acids (PAA) solution was obtained. The appropriate amount of DMAc was added to prepare a 12 wt % PAA solution, and 12.90 g of the solution was poured into a glass petri dish. The solution was heated under a vacuum to evaporate the solvent slowly and form a film. The film was imidized at 310° C. under a nitrogen atmosphere to generate a fluorinated polyimide film. As a skilled artisan would understand, the above method for fabricating fluorinated polyimide films is not limited by particular process parameters such chemicals used, equipment types, temperatures, etc. Various adaptations and variations of the method may be implemented that would lead to fabricating the fluorinated polyimide films.

### D. 3D Porous/Microporous Graphene

A method for fabricating a fPI-3GPG is disclosed. In an exemplary aspect, fPI-3DPG was prepared with polymer thin films by transient laser photothermal heating; ˜120 μm thick fPI thin films were synthesized as described above. 3DPG was irradiated with the wavelength of 10.6 μm in optimized ambient conditions of 1.65 W laser power, 3.5 in s⁻¹ engraving speed, and 1000 pulse per inch (PPI). The laser irradiation induced local photothermal heating of the fPI film, whose temperature reached over 1000° C. owing to the absorption of the irradiated light within the focused area of the laser. Consequently, the sp³ carbons in the fPI film were converted into sp²-carbons. This graphitization of polymers containing aromatic carbons results in highly ordered graphitic structures with heterogeneous micro-/nanoscale pores, unlike conventional thermal processing using furnaces, wherein the carbonization yields amorphous carbon structures. The diagram of FIG. 1A shows that fPI-3DPG includes nanoscale and meso-/macropores because of the fluorinated gaseous molecules in the chemical structure of the fPI. The local photothermal heating of the fPI films vaporizes F gas molecules in addition to the H₂, N₂, and O₂ gases, forming micro-/meso-/macroscale porous structures. It is understood that other laser types, wavelengths, laser powers, and pulse sequences may be used to fabricate the 3D porous graphene.

### E. Raman and XRD Characterization

The crystalline size in a axis (Lₐ) was determined by the equation below:

$${L}_{a} = ( 2.4 \times 1 {0}^{- 10} ) \times {λ}_{l}^{4} \times ( \frac{{I}_{G}}{{I}_{D}} )$$

where λ₁ is the wavelength of the Raman laser (λ₁=514 nm) and the intensities of G peak (IG) and D peak (I_{D}) were measured by Raman spectroscopy.

According to Bragg's law, the distance between graphene interlayers was calculated from the below equation:

λ=2d sin(θ)

where λ is the wavelength of the X-ray beam (λ=0.154 nm), d is the distance between the graphene layers in 3DPG (d=0.39 nm from TEM result), and θ is the diffraction angle from the XRD results. The fPI-3DPG exhibited two major peaks at 2θ=21.5° and 25.8° corresponding to the (002) plane, with d values of 0.413 and 0.345 nm, respectively. The average lattice spacing of the d values was determined to be ˜0.38 nm which is consistent with the average lattice spacing value obtained from TEM results.

### F. Structural Characterization

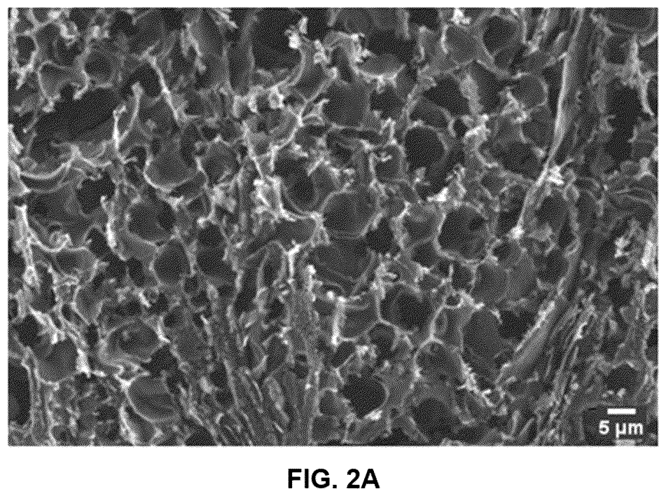

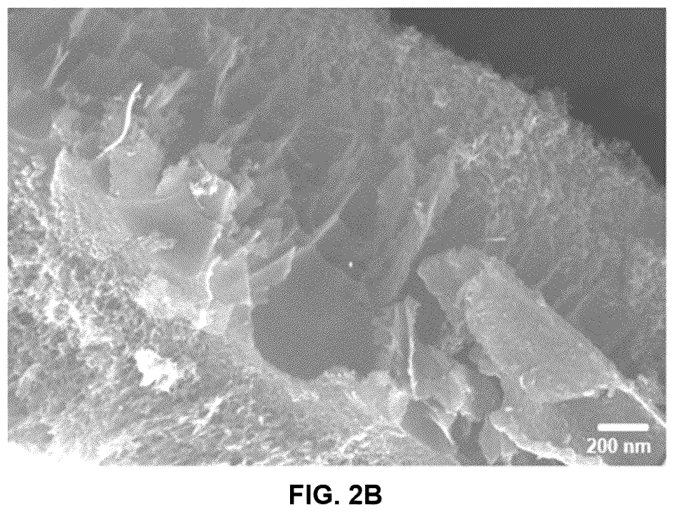

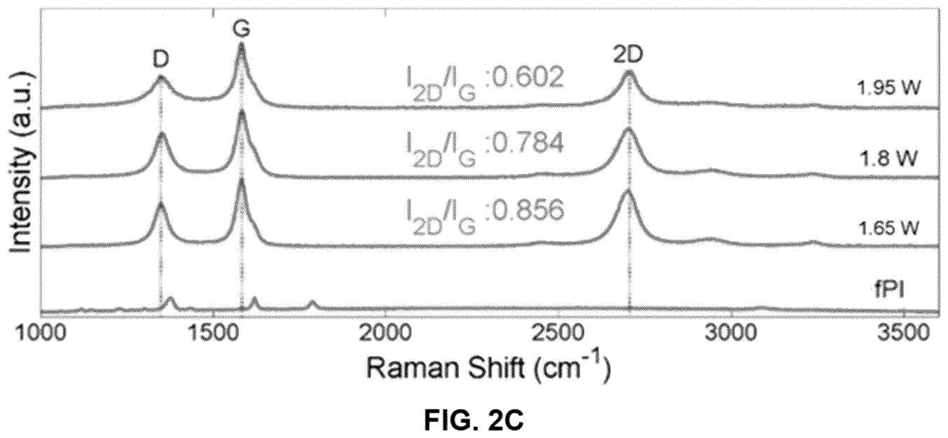

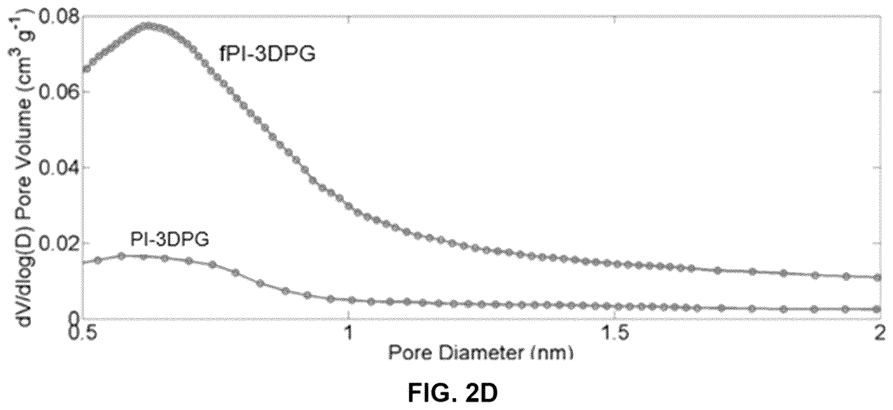

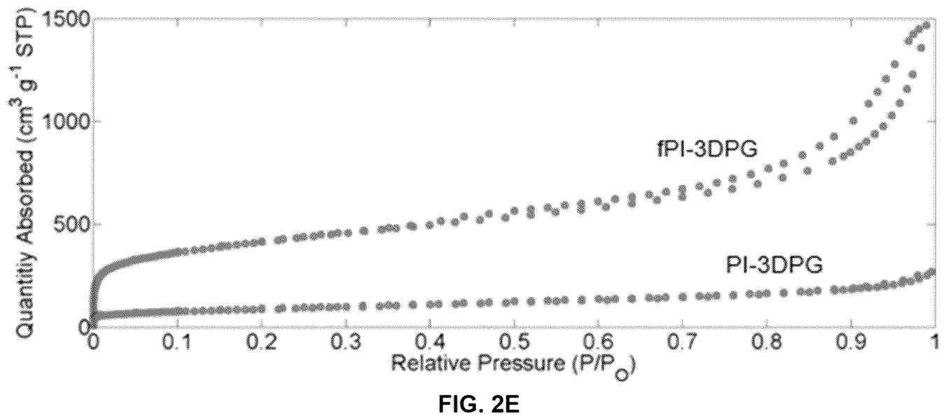

The structural morphology of fPI-3DPG was investigated by scanning electron microscopy (SEM), transmission electron microscopy (TEM), and X-ray diffraction (XRD). The cross-sectional SEM image revealed the formation of 70 μm thick fPI-3DPG in a ˜120 μm thick fPI film. Heterogeneous macropores with pore size distributions ˜1.5-7 μm were present in fPI-3DPG, as shown in the SEM image of FIG. 2A. The laser-based manufacturing of fluorinated polymer precursor films enabled the formation of nanosized pores in addition to the macropores. Numerous mesopores and micropores were formed as a result of the vaporization of the gaseous product during laser graphitization (FIG. 2B). The TEM image of fPI-3DPG showed that the interlayer spacing of graphene in fPI-3DPG was 0.36-0.41 nm, i.e., a mean spacing of ˜0.385 nm, whereas the lattice spacing of laser-induced graphene was 0.34 nm. The wider lattice spacing in fPI-3DPG rather than that in PI-3DPG is attributable to the discharge of fluorine-based gaseous products, including CF₃, CF, CHF₂, CH₂F, and COF₂ during graphitization of fPI, which also contributes to the formation of nanoscale pores. The average lattice spacing of ˜0.38 nm of the fPI-3DPG pertains to the gap between two near (002) planes)(21.5°<2θ<2θ<25.8°) in the graphene layers of fPI-3DPG, indicating that the interlayer spacing determined by TEM is consistent with that calculated by XRD using Bragg's equation (˜0.38 nm). These results indicate the formation of multiscale pore structures with highly ordered fPI-3DPG graphitic structures.

The crystalline structures of fPI-3DPG were characterized by Raman spectroscopy and X-ray photoelectron spectroscopy (XPS). The Raman spectra of plain fPI films and fPI-3DPG fabricated were obtained at laser powers (Pₗₐₛₑᵣ) of 1.65, 1.8, and 1.95 W at a constant scanning speed of 3.5 in s⁻¹ and 1000 PPI (FIG. 2C). The fPI-3DPG fabricated at Pₗₐₛₑᵣ=1.65 W showed a sharp 2D peak with a 2D/G peak intensity ratio of ˜1 and a low D/G peak intensity ratio, indicating minimum defects. The small D/G intensity ratio indicates a high degree of graphitization as opposed to carbonization, and the sharp 2D peak indicates the presence of randomly stacked sp²-hybridized graphene layers in the porous 3D structures. The large crystalline size (Lₐ) along the α-axis of graphitic structures (31 nm) as determined from the intensities of G and D peaks (I_{G}/I_{D}) further confirmed the high degree of graphitization in fPI-3DPG. The XPS spectra revealed the dominant C1s characteristic peak, centered at 284.2 eV, with negligible O1s and F1s peaks, indicating predominant C-C bonds in the porous graphene. Thus, the Raman and XPS spectra corroborate the high crystallinity and high degree of graphitization in fPI-3DPG fabricated by the laser photothermal irradiation of fPI thin films.

The Ar adsorption-desorption isotherms were acquired to assess the specific surface area and porosity of fPI-3DPG with comparison to those of PI-3DPG. fPI-3DPG exhibited type I and IV isotherms, which indicate hierarchical porous structures, including the micro- and mesopores in fPI-3DPG. In comparison, PI-3DPG exhibited only type IV isotherms, indicating that the porous structure of PI-3DPG was primarily due to mesopores. The strong type I characteristic of the isotherm of fPI-3DPG implies a significant increase in the micropores, confirming the presence of micro-/meso-/macroscale porous structures of graphene formed from the fPI. The micropore volumes and sizes of fPI-3DPG and PI-3DPG based on the Horvath-Kawazoe (H-K) method were also evaluated (FIG. 2D) to determine the micropore size distribution from the quantity of adsorbate on the surface as a function of its pressure at a constant temperature. The H-K analysis shows that fPI-3DPG had approximately five times higher micropore volume (0.511 cm³ g⁻¹) than PI-3DPG (0.105 cm³ g⁻¹). Additionally, although the average micropore diameters of fPI-3DPG and PI-3DPG were nearly similar (˜0.79 and 0.77 nm, respectively), fPI-3DPG had significantly more micropores than PI-3DPG (FIG. 2D). The specific surface areas of fPI-3DPG and PI-3DPG were evaluated to be 1309.7 and 272.8 m² g⁻¹, respectively (FIG. 2E), using the Brunauer-Emmett-Teller (BET) equation. According to the BET analysis, the specific surface area of fPI-3DPG was 4.8 times higher than that of PI-3DPG. The nearly fivefold increase in the specific surface area of fPI-3DPG is attributed to the increase in the number of micropores by the releasing of fluorine-based gaseous products in laser graphitization. The BET surface analysis infers the higher specific surface area of fPI-3DPG, attributed to the multiscale porous structures with numerous micropores, than that of PI-3DPG.

### G. Optical Characteristics

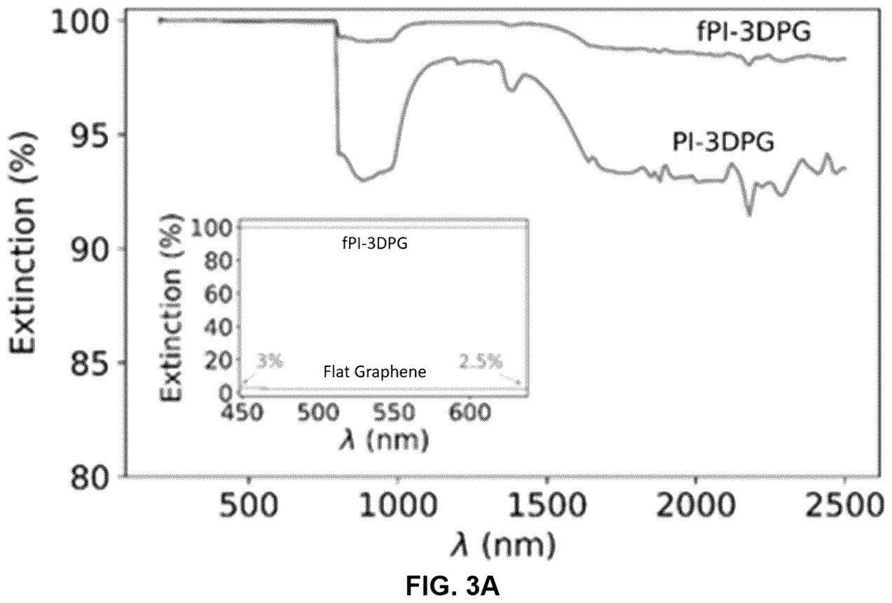

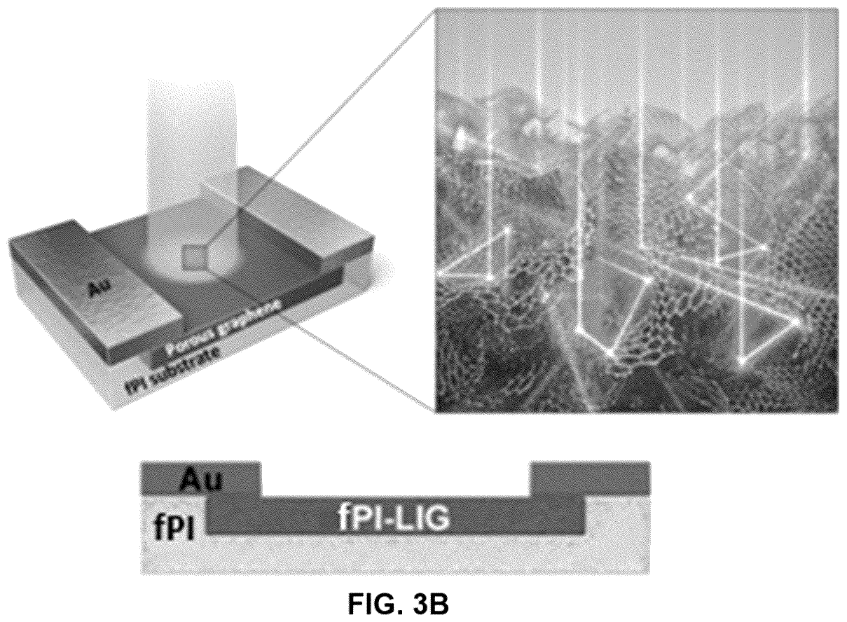

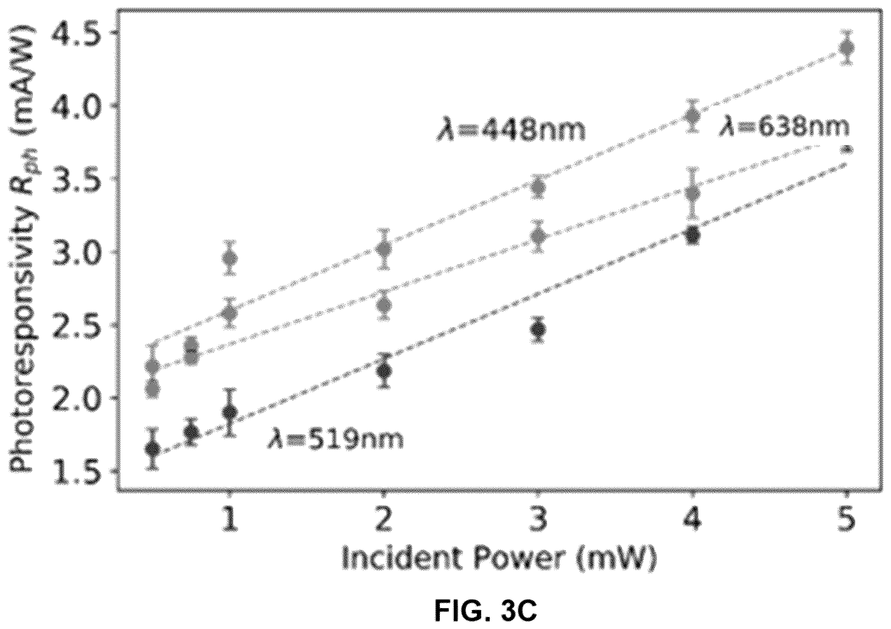

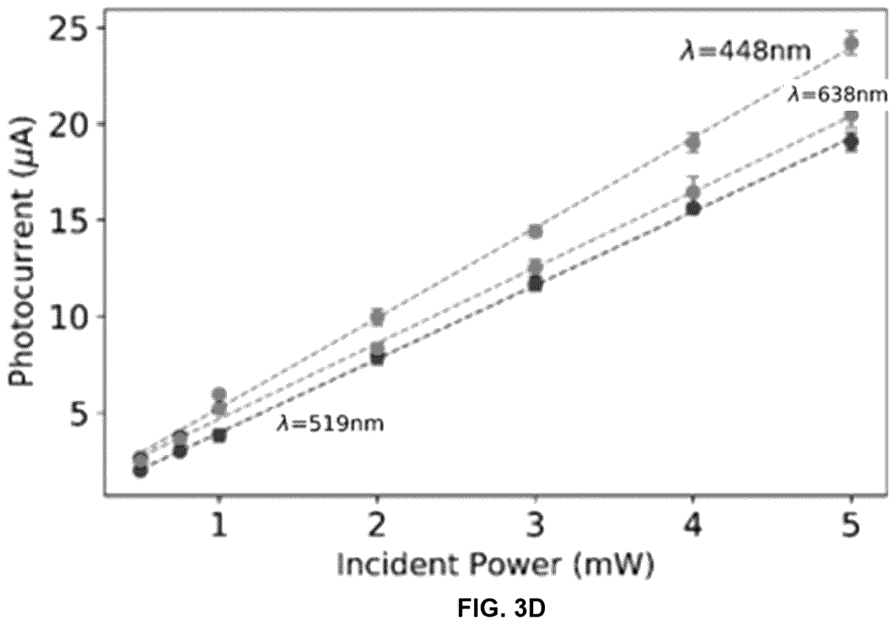

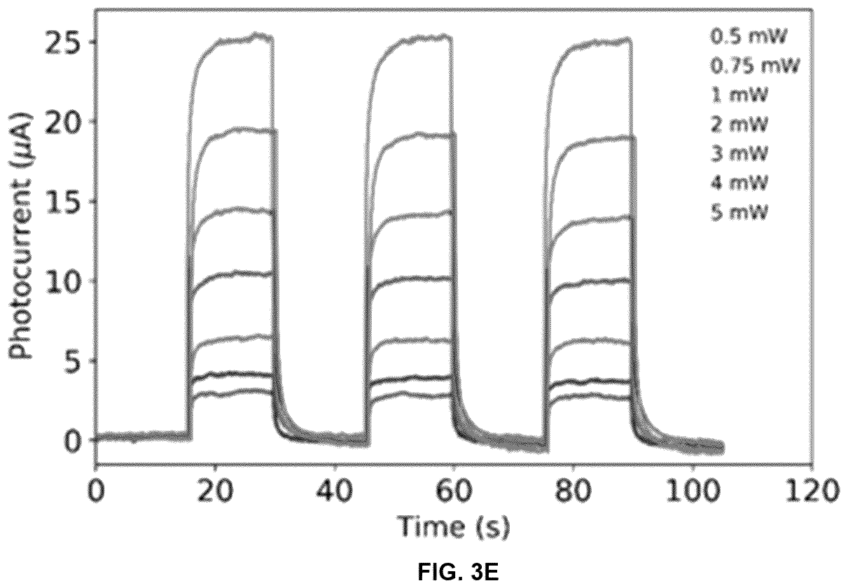

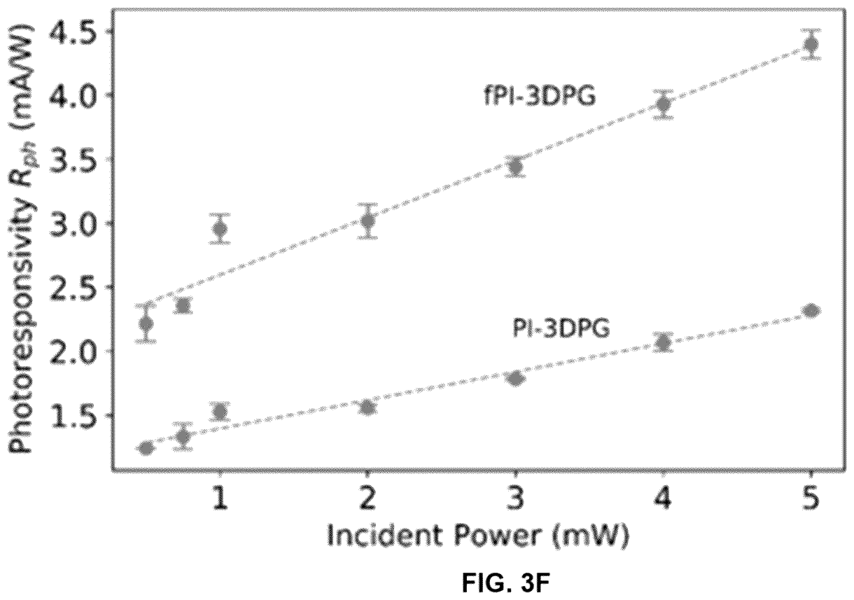

To investigate the optical characteristics of fPI-3DPG, UV-Vis spectroscopy of fPI-3DPG was performed (FIG. 3A). fPI-3DPG showed a high optical extinction of 100% up to 800 nm, including the entire visible-light spectrum. The extinction of fPI-3DPG was 40 times higher than that of flat graphene (fabricated by chemical vapor deposition) in the visible wavelength range 448-638 nm, as shown in the inset of FIG. 3A. The optical absorption enhancement of 3DPG is likely due to two mechanisms: 1) optically resonant porous structures and 2) specific surfaces of 3DPG, as schematized in FIG. 3B.

To account for the enhanced optical absorption of the 3DPG caused by its high specific surface of the 3DPG, the analytical areal ratio of porous graphene was determined and compared to that of flat monolayer graphene (Aₚₒᵣₒᵤₛ/A_{flat}) using SEM images of the 3DPG. The pores of the 3DPG have spherical shapes based on the SEM image and the area of the porous graphene structure is expressed as:

$${A}_{p o r o u s} = W \times L - M {\sum }_{i} π {r}_{i}^{2} + N {\sum }_{i} 4 π {r}_{i}^{2}$$

where W and L are the width and length of the cross-section porous structure from the top-view SEM image, respectively. M is the number of micrometer-scale pores shown in the top-view SEM image. N is the total number of micrometer-scale pores in the fPI-3DPG, and rᵢ is the pore radius distribution.
M Σᵢπr²=Area of the cross-sectional pores
W×L=Total Area
W×L−MΣᵢπrᵢ²=Area of bulk graphene without pores in the top-view SEM image
N×Σᵢ4πrᵢ²=Total area of pores in the fPI-3DPG

The area of the flat monolayer graphene is the same as that of the cross-section area of porous graphene (W×L). Therefore, the developed analytical model for the areal ratio of Aₚₒᵣₒᵤₛ/A_{flat} is expressed as:

$$\frac{{A}_{p o r o u s}}{{A}_{flat}} = \frac{W \times L - M {\sum }_{i} π {r}_{i}^{2} + N {\sum }_{i} 4 π {r}_{i}^{2}}{W \times L}$$

The developed analytical model estimated Aₚₒᵣₒᵤₛ/A_{flat} to be 17.4. The areal ratio enhancement was underestimated as it only takes into account the micrometer-scale pores of the fPI-3DPG. However, fPI-3DPG also possesses abundant nano-scale pores, which substantially contribute to the enhancement of specific surface area.

The parameters of L, W, M, N, D_{avg} and rᵢ were determined from the SEM image of the porous graphene structures using ImageJ software. (L=112.5 μm, W=82.5 μm, M=148, D_{avg}=3.54 μm, and thickness of 3DPG=70 μm).
M is the number of pores on top-view SEM
N=Number of pores on top×Number of layers
D_{avg}=The average diameter of the pores
Number of Layers=Thickness of 3DPG/D_{avg}=19.75
N=148×19.75=2923
MΣᵢπrᵢ²=Area of the cross-sectional pores=1949.56 μm²
W×L=Total Area=9281.3 μm²
N×Σᵢ4πrᵢ²=Total area of pores=161371.15 μm²

$$\frac{{A}_{p o r o u s}}{{A}_{flat}} = \frac{W \times L - M {\sum }_{i} π {r}_{i}^{2} + N {\sum }_{i} 4 π {r}_{i}^{2}}{W \times L} = 17.4$$

L and W were quantified from the SEM image of the fPI-3DPG.

Incident photons are resonant and trapped in the pores of 3DPG whose characteristic pore sizes are same as the wavelength of the incident light. Light is scattered and reflected in the interconnected pores, which allows for a strong interaction between the 3D graphene nanostructures and light, thereby enhancing the optical absorption. To account for the structural effects of multiscale pores on light absorption, a model was developed that relates the extinction coefficient (ε) of fPI-3DPG and pore size (Dₚₒᵣₑ) distributions based on the geometrical optics approximation. The developed model indicates that pores with Dₚₒᵣₑ in the same order of magnitude as incident λ_{light} contribute to the extinction enhancement, according to ε=(4.8/Dₚₒᵣₑ)·(1−ϕ), and light absorption, where ϕ is the porosity of the porous graphene (ε/εₘₐₓ>0.37 (=1/e) at Dₚₒᵣₑ/I_{light}<5.

To account for the enhanced optical absorption of the 3DPG resulting from mechanism of optically resonant porous structures, we achieved an analytical relation between the extinction coefficient (ε) of fPI-3DPG and the pore-size (Dₚₒᵣₑ) distribution using a model based on the geometrical optics approximation. The developed model is expressed below and is valid for materials with pore diameters greater than the wavelength of the incident light (Dₚₒᵣₑ/λ>>1).

$$ε = \frac{4.8}{{D}_{pore}} ( 1 - ϕ )$$

where Dₚₒᵣₑ and ϕ are pore diameter and porosity, respectively. The porosity distribution of the fPI-3DPG was quantified via the following equation:

$${ϕ}_{i} = \frac{{V}_{pores}}{{V}_{total}} = \frac{\frac{4}{3} N π {r}_{i}^{3}}{W \times L \times {t}_{a v g}}$$

where rᵢ is the pore radius distribution and t_{avg} is the average thickness of porous graphene quantified from the SEM images using ImageJ software.

According to the developed extinction model, the extinction coefficient is greater at smaller pore diameters, indicating the structural effects of multi-scale porous 3DPG on extinction. The extinction coefficient linearly relates to the absorption coefficient via the following equation:

$$ε = \frac{α λ}{4 π}$$

where α is the absorption coefficient, and it enhances with the enhancement of extinction coefficient (ε). The theoretical model reveals that enhancement of optical absorption is due to an increase in the extinction coefficient caused by the smaller pore sizes of the 3DPG (Dₚₒᵣₑ/λ<16).

In addition to optical resonance, the significantly increased specific surface area of fPI-3DPG contributes to optical absorption enhancement, as revealed by the UV-Vis spectra (inset of FIG. 3A). To quantify the effects of the increase in the light-absorbing surface area, the analytical areal ratio of porous graphene structures to the flat graphene was estimated (Aₚₒᵣₒᵤₛ/A_{flat}), which was determined as 17.4 based on the geometrical modeling of the porous structures using SEM images of the 3DPG structures. The lower analytical areal ratio compared to the factor of 40 (multiplicative increase in extinction) is attributable to the optical resonance enhancement via light scattering and diffusion in the interconnected pore structures. The optical resonance was not considered in the geometrical modeling. The combined enhancement mechanisms, i.e., optical resonance and increased specific surface area of fPI-3DPG, reveal a method of enhancing the light-matter interaction of graphene via porous structures. The 100% absorption in the visible-light wavelength range exhibited by 3DPG signifies the prospect of 3DPG in optoelectronic applications that use broadband optical sensing with high sensitivity.

### H. Photodetector Devices

To demonstrate the potential of fPI-3DPG as a functional optoelectronic material, fPI-3DPG based photodetector (PD) devices were made (FIG. 3B) and the photoresponse current Iₚₕ (=I_{lluminated}−I_{dark}) of fPI-3DPG and PI-3DPG PD devices at various λ_{light=}448, 519, and 638 nm and constant I_{bias}=0.1 V were measured. A high V_{bias} increases the photoresponse current, but it undesirably increases the dark current and thermoelectric noise as well. The Rₚₕ was measured as 4.39, 3.78, and 3.83 mA W⁻¹ at 448, 519, and 638 nm, respectively (FIG. 3C). The Rₚₕ at 448 nm was 14% and 11% greater than that at 519 nm and 638 nm, respectively. The higher Rₚₕ at 448 nm is attributable to the linearly increasing number of photoexcited charge carriers in response to the photon energy of the shorter λ_{light}.

All photocurrent measurements were conducted at bias voltages of 0.1 V considering that higher I_{bias} increased photoresponse, but also increased dark current and thermoelectric noise. Second, a device heat treatment was performed to remove impurities inside the pores and obtain a consistent dark current, maximum photocurrent, and lower noise over multiple cycles. The device was heated in an oven at 65° C. for varying times from 30 to 120 minutes, with 30 minutes being determined as the optimal heating time for better performance

Third, photocurrent measurements were performed at different locations of the 3DPG channel for the focused laser beam spot to check the location sensitivity of the photodetector. Good photoresponsivity was achieved through irradiating the light at the negative junction of the 3DPG channel and gold electrode This is attributed to the smaller illumination area at the junction, which directly affects the photoresponsivity compared to the center of the channel. (Rₚₕ=Iₚₕ/(Aᵢₗₗᵤₘ×D_{power}) where, Aᵢₗₗᵤₘ is the illuminated area and D_{power} is power density determined as D_{power}=laser Power/A_{beam}). All the photoresponse characterization were carried out by focusing light spots to the center in between the negative junction of the 3DPG channel and gold electrode to minimize electron-hole pairs recombination rate. The fPI-3DPG photodetector also shows consistent photoresponse up to 24 hours, indicating that humidity does not degrade the device To eliminate the humidity effect after 24 hours, the device was heated in the oven at 65° C. for 30 minutes prior to conducting the photoresponse characterization.

Maximum photocurrent, I_{pc}˜24.19 μA, was generated through incident power (Pᵢₙ) of 5.5×10⁻³ W for laser light wavelength of 448 nm. The incident power was calculated by multiplying illumination area and density power (Pᵢₙ=A_{illum.}×D_{power}), which are quantified through (A_{illum.}=R_{beam}×channel width) and D_{power}=laser Power/A_{beam}), respectively. The photoresponsivity, Rₚₕ, at λ_{light}=448 nm and V_{bias}=0.1 V was calculated by Rₚₕ=Iₚₕ/Pᵢₙ=(24.19×10⁻³ mA)/(5.5×10⁻³ W)≈4.39 mA W⁻¹. Rₚₕ, at λ_{light}=448 nm and I_{bias}=1 V was calculated to be Rₚₕ=(175.01×10⁻³ mA)/(5.5×10⁻³ W) ≈4.39 mA W⁻¹. The quantum efficiency (QE), which is equal to the number of electron-hole pairs per second collected to generate photocurrent, was calculated by QE=(Rₚₕ×Eₚₕ)/e, where e=1.6×10⁻¹⁹ C is the electron charge. The sensitivity of the porous graphene photodetector was estimated through determining signal-to-noise ratio (SNR) and noise equivalent power (NEP). The SNR was calculated by Rₚₕ=Iₚₕ/Nᵣₘₛ=24.19 μA/0.1165 μA≈207.64, where Nᵣₘₛ is the root mean squared dark current.

The noise equivalent power (NEP), which is the incident optical power required when the signal-to-noise ratio is unity, was calculated by NEP=Iₜₙ/Rₚₕ, where Iₜₙ is the noise current at a bandwidth of 1 Hz. The Iₜₙ was calculated by Iₜₙ=(Iₛₙ²+I_{Jn}²)^{1/2}, where Iₛₙ and I_{JN} were calculated based on the following equations:

$$\begin{matrix}{I}_{s n} = \sqrt{2 q ( {I}_{p h} + {I}_{dark} )} \\ {I}_{Jn} = \sqrt{\frac{4 {k}_{B} T}{R}}\end{matrix}$$

where k_{B}=1.38×10⁻²³ J K⁻¹ is the Boltzmann constant, T is the absolute temperate in Kelvin, and R is the resistance of the photodetector.

When the photoconductive channel of the 3DPG is illuminated, photoexcited electron-hole (e-h) pairs are generated. The e-h pairs are separated by V_{bias}, and the separated electrons travel through the 3DPG channel to the source/drain electrodes. The Rₚₕ increased with increasing Pᵢₙ as opposed to the trend of Rₚₕ decreasing with increasing Pᵢₙ for 2D-material-based photodetectors. Increasing the incident laser power increases the photoexcited carrier density, by which the carrier recombination rate increases and Rₚₕ decreases. This disparate trend of 3DPG photodetectors is ascribed to the 3D porous structures, which facilitate an increase in the light-absorbing area, generating numerous photoexcited e-h pairs at high Pᵢₙ, while reducing the carrier recombination rate because of light scattering and trapping of the photoexcited carriers. Our fPI-3DPG photodetectors made of four different devices exhibited reproducible photoresponse with Rₚₕ≈3.78 mA W⁻¹ at λ_{light}=519 nm. The Rₚₕ of fPI-3DPG is more than three orders of magnitude greater than that of a monolayer graphene photodetector for 519 nm laser illumination and superior to other graphene-only-based photodetectors reported to date.

Asymmetric contact electrodes with two distinct metals, such as Au and Ti, in photodetector devices induce photothermoelectric effects. Hence, the fPI-3DPG photodetectors, which can detect light based on the photoconductive mechanism, can be further optimized by incorporating asymmetric contact electrodes.

To characterize the light detection sensitivity to dark current, the noise equivalent power (NEP) of the fPI-3DPG photodetector devices was evaluated. The fPI-3DPG photodetectors showed an ultralow NEP of 0.54×10⁻¹¹ W Hz^{-1/2} at V_{bias}=1 V and λ_{light}=448 nm, which is two orders of magnitude smaller than the NEP of 3D graphene foam PDs (0.6×10⁻⁹ W Hz^{-1/2} at λ_{light}=532 nm). A smaller NEP corresponds to a more sensitive detector. The quantum efficiency (QE) of the fPI-3DPG PDs was determined to be 1.22, 0.90, and 0.74% at λ_{light}=448, 519, and 638 nm, respectively, according to QE_{λ}=Rₚₕ·Eₚₕ/e=(Rₚₕ/λ)·(hc/e), where e=1.6×10⁻¹⁹ C is the electron charge. The QE indicates the ratio of the number of charge carriers collected to the number of incident photons. Compared to the QE at λ_{light}=448, the QE at λ_{light}=519 and 638 nm decreased by 25% and 38%, respectively. The fPI-3DPG PD showed nearly an order of magnitude higher QE of 8.81% at V_{bias}=1 V than the QEs at V_{bias}=0.1 V. As λ_{light} decreases and V_{bias} increases, the number of photoexcited charge carriers collected at a drain electrode increases and the QE increases. The excellent performance of fPI-3DPG photodetectors, as inferred by Rₚₕ=31.82 mA W⁻¹, ultralow NEP of 0.54×10⁻¹¹ W Hz^{-1/2}, and QE_{λ}=8.81% (V_{bias}=1 V), indicate its potential for high-sensitivity optoelectronics and flexible optical sensing applications.

The photoresponse of the fPI-3DPG photodetector at various Pᵢₙ of 0.5-5 mW and V_{bias}=0.1 V (FIG. 3D) indicated a linear increase in the photocurrents with a factor of ˜1.5 per unit increase in Pᵢₙ, which is attributable to the linearly increasing number of photoexcited carriers. The photocurrent generated at λ_{light}=448 nm was 21% and 15% greater than that measured at λ_{light}=519 and 638 nm, respectively. The higher photocurrent is consistent with the higher photon energy (˜15%-29%) at a shorter wavelength, based on the Planck's equation (Eₚₕ=hc/λ), where h=6.63×10⁻³⁴ J s is the Planck constant and c=3×10⁸ m s⁻¹ is the speed of light.

The dynamic photoresponse was characterized at λ_{light}=448, 519, and 638 nm to evaluate the broadband photoresponse capability and the photoresponse to cyclic incident light (FIG. 3E). The fPI-3DPG PD device showed a consistent photoresponse over three on-off (˜15 s) cycles, at λ_{light}=448 nm at various Pᵢₙ ranging 0.5-5 mW, and exhibited an ultrahigh signal-to-noise ratio (SNR) of ˜208. The response time was estimated to be ˜0.90 and 1.34 s for the rise and fall times (τᵣᵢₛₑ and τ_{fall}), respectively. The relatively low response time is likely attributable to the light scattering and trapping of photoexcited carriers in the interconnected pores of the 3DPG structures, which increase the distance to be traveled by the photoexcited carriers in the 3DPG structures to be collected on the source/drain electrodes for the photoelectric signal measurements. The response time can be reduced by using a short channel or asymmetric contact electrodes. Thus, the fPI-3DPG photodetectors offer a broadband visible-light photoresponse with an ultrahigh sensitivity of ˜208 SNR.

To investigate the responsivity enhancement mechanisms, the photoresponse and responsivity of the fPI-3DPG photodetectors were compared with those of the PI-3DPG photodetectors. The Rₚₕ of the fPI-3DPG photodetector at λ_{light}=448 nm (4.4 mA W⁻¹) was 48% greater than that of the PI-3DPG photodetector (2.3 mA W⁻¹) (FIG. 3F). The nearly two-fold responsivity enhancement is ascribed to the optical absorption enhancement entailed by the optical resonance enhancement and increased specific surface area. The comparison of photoresponse and responsivity characteristics of fPI-3DPG and PI-3DPG PDs at various λ_{light}=448, 519, and 638 nm and various Pᵢₙ=0.5-5 mW (V_{bias}=0.1 V) reveals the nearly two-fold responsivity and photoresponse of the fPI-3DPG PD compared to those of the PI-3DPG PD. This performance enhancement implies that the enhanced optical absorption of the fPI-3DPG leads to responsivity enhancement via the mechanisms of optically resonant porous structures and increased specific surface area.

To evaluate the electric field effect mobility of the fPI-3DPG, electrical characterization was conducted on fPI-3DPG using a liquid-gated field effect transistor configuration. The 2 μL PBS solution was dropped as the dielectric layer and a standard Ag/AgCl reference electrode, serving as the gate electrode, was immersed in the PBS solution. The drain voltage was fixed at 2 V and the gate voltage was swept from −5 V to 10 V. The transconductance curve shows that the current in the device ranges from 9.69 mA to 23.08 mA, with the highest current obtained at V_{G}=−4.69 V and the smallest at V_{G}=5.42 V.

As the gate voltage increases on the right side of the highest point, the current decreases, indicating that fewer holes are involved in the current conductance and demonstrating the p-type characteristics of the fPI-3DPG graphene. On the opposite side of this point, the current also decreases as V_{G} decreases from −4.69 to −5 V, which can be explained by the depletion of minority carriers, electrons, from the 3DPG channel as the negative gate voltage decreases. Additionally, the current plot is relatively flat with a saturation current of 5.4-6.5 mA when V_{G} is in the high, positive range of 5.71-10 V.

It was reported that the P-doping effect in graphene has also resulted in a very large Dirac point of 20 V, which was controlled with the top passivation by PVA or PDMS. Field effect mobility values can be quantified using the left and right-side branches of the transfer characteristics for holes and electrons using the equation μ=gₘ/LWCV_{DS}. Here, gₘ is the transconductance, C is the dielectric capacitance, and L and W are the length and width of the 3DPG channel, respectively. From the transfer characteristics of fPI-3DPG, the hole mobility can be obtained as 4.37×10¹⁶ cm²/V s. The source-drain current (I_{DS}-V_{DS}) characteristic of fPI-3DPG shown in Fig. S20b is linear for small bias voltages, indicating an ohmic-like contact with a resistance of 169.49Ω.

The Table below shows comparisons of the presently described graphene-based photodetectors and previously reported graphene-based detectors.

| | | | | | | Rₚₕ |
|---|---|---|---|---|---|---|
| | Wavelengths | Incident power | V_{gate} | V_{bias} | Iₚₕ | (mA |
| Active material | (nm) | (mW) | (V) | (V) | (μA) | W⁻¹) |
| 3D porous graphene (Present | 448 | 5 | 0 | 0.1 | 24.19 | 4.4 |
| Application) | | | | | | |
| Twisted bilayer graphene | 532 | 5 | 0 | 0 | 0.63 | 1 |
| Monolayer graphene | 1550 | 3 | 80 | 0 | NA | 0.5 |
| graphene quantum dot-like | 532 | <1 | 0 | 0.02 | 0.006 | 1250 |
| (GQD)-arrays structure | | | | | | |
| Monolayer graphene | 515 | 10 | 0 | 0 | 10⁻⁶ | 0.001 |
| graphene quantum dot-like | 635 | 0.05 | 0 | 1 | 6.5 | 290 |
| (GQD)-arrays structure | | | | | | |
| Pristine graphene | 635 | 0.05 | 0 | 1 | NA | 0.22 |
| Partially suspended graphene | 476 | 0.1 | 10 | 0 | 0.8 | 2.7 |
| Fully suspended graphene | 532 | 0.08 | 0 | 0.1 | 0.005 | ~0.4 |
| microribbon array | | | | | | |
| 3D graphene foam | 532 | NA | 0 | 0.01 | 5.5 | NA |
| 3D graphene foam with | 532 | NA | 0 | 0.01 | 52 | 1000 |
| asymmetric Au/Ti contacts | | | | | | |

### i. Mechanical/Photocurrent Testing of Devices

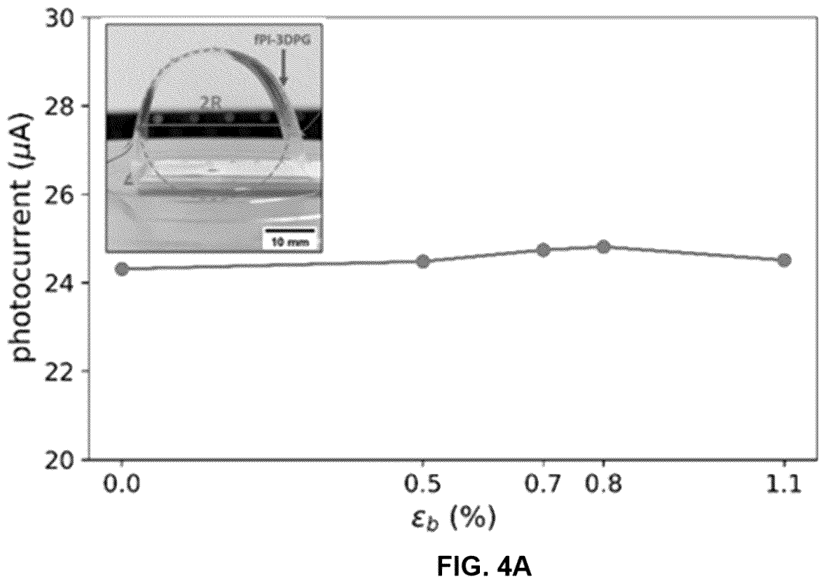

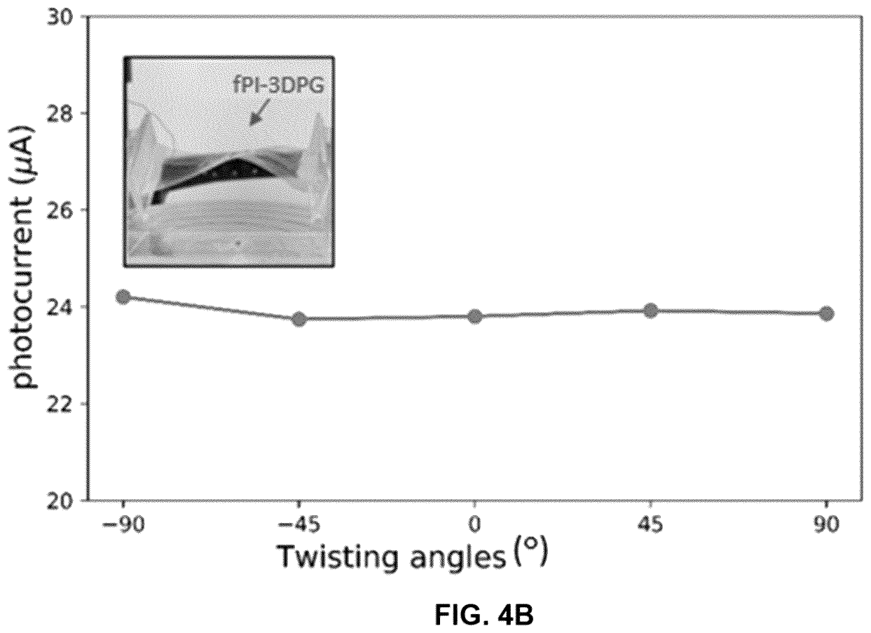

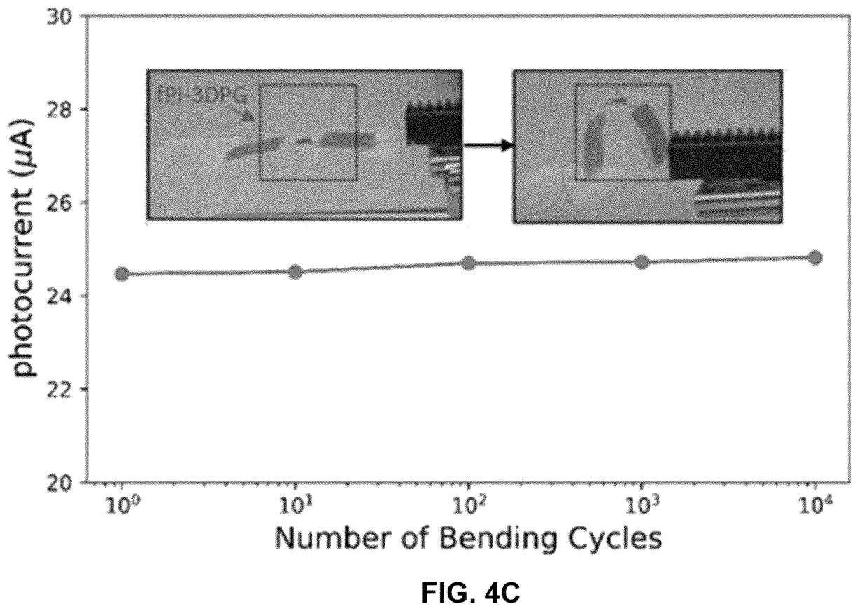

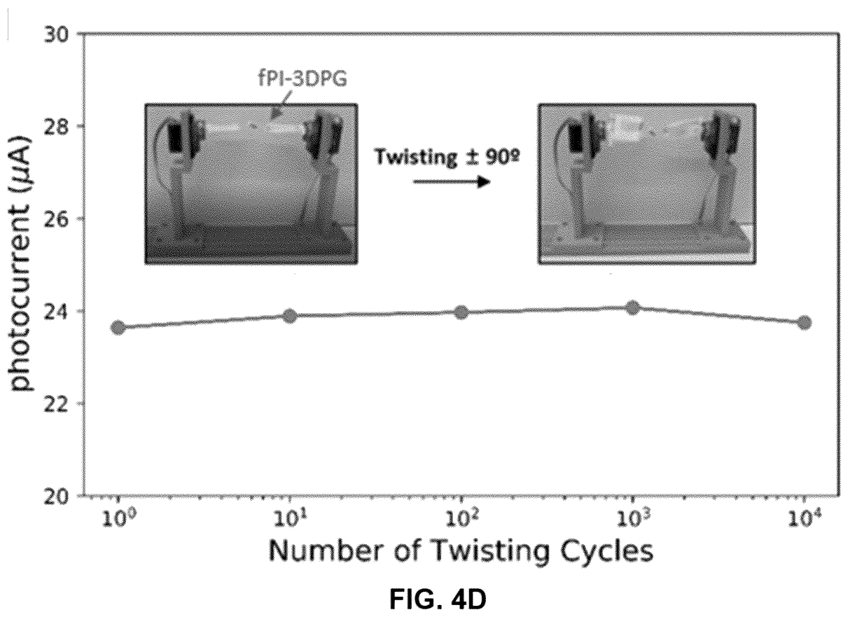

To demonstrate the potential of the high-performance photodetector in reliable, durable, flexible, and wearable optical sensor devices under various mechanical strains, the photoresponse under bending and twisting was characterized. The fPI-3DPG photodetectors generated a constant photocurrent under bending strains up to 1.1% (FIG. 4A) and under twisting from −90° to +90° (FIG. 4B), indicating their strain-independent photodetection. Moreover, the consistent photoresponse of the fPI-3DPG photodetector under cyclic bending (1.1%) and twisting (from −90° to +90° up to 10,000 cycles ascertains the mechanical stability of fPI-3DPG (FIG. 4C, FIG. 4D). Such consistent and reliable photodetection is attributed to the mechanical robustness and durability of the 3DPG structures and flexibility of the fPI films. Therefore, the fPI-3DPG photodetector is useful as a functional element of flexible optical sensors for integration with flexible and wearable integrated systems.

### ii. Bio-Based Photodetector Devices and Characterization

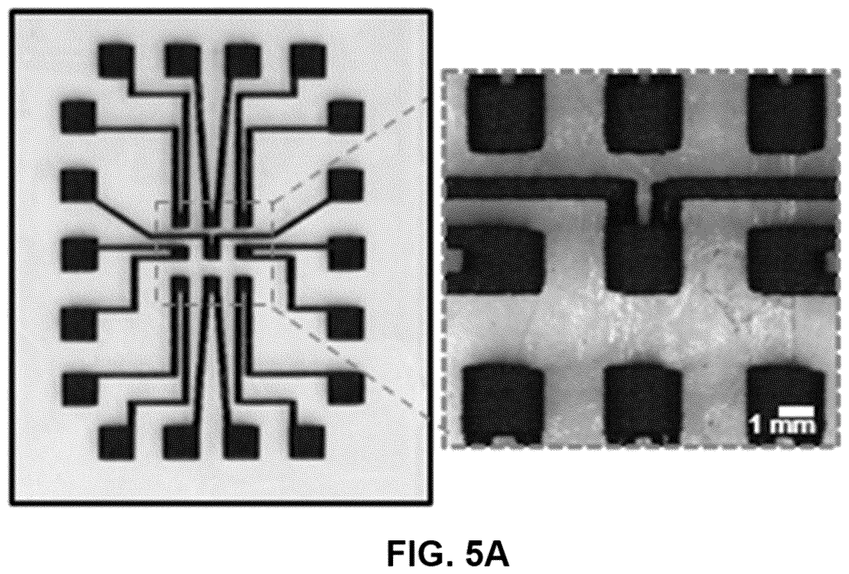

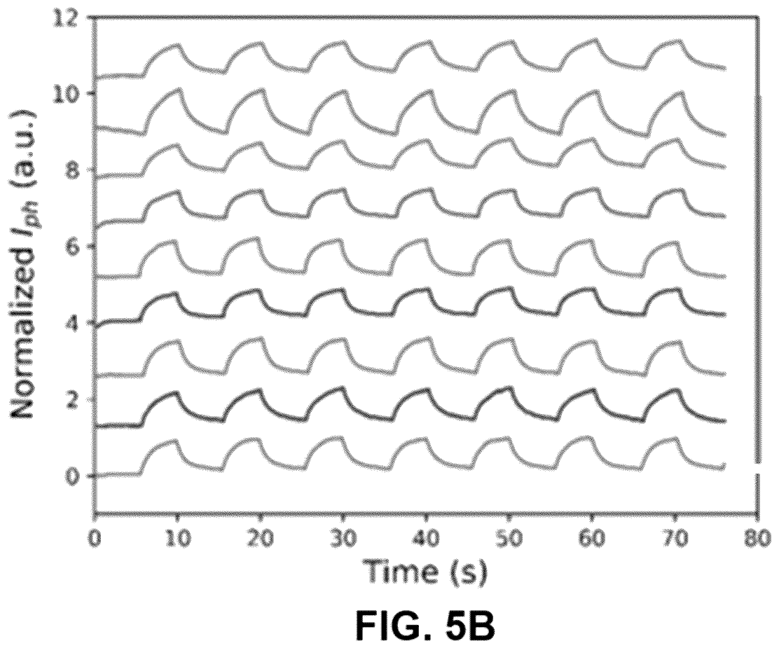

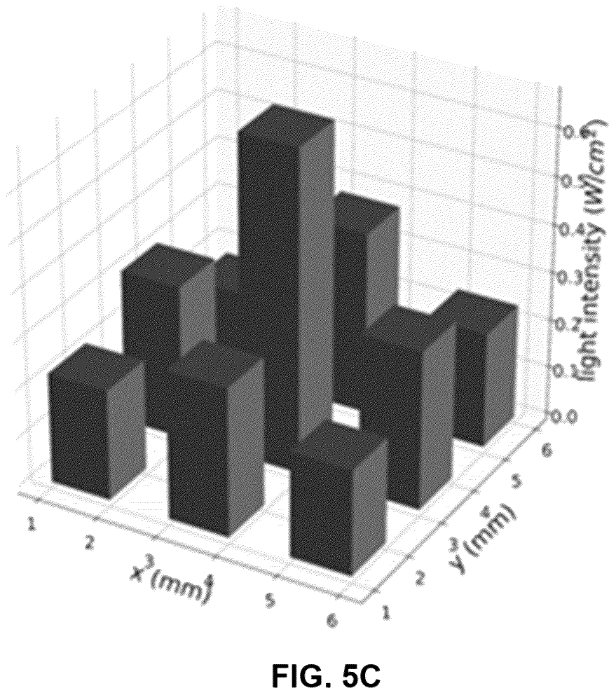

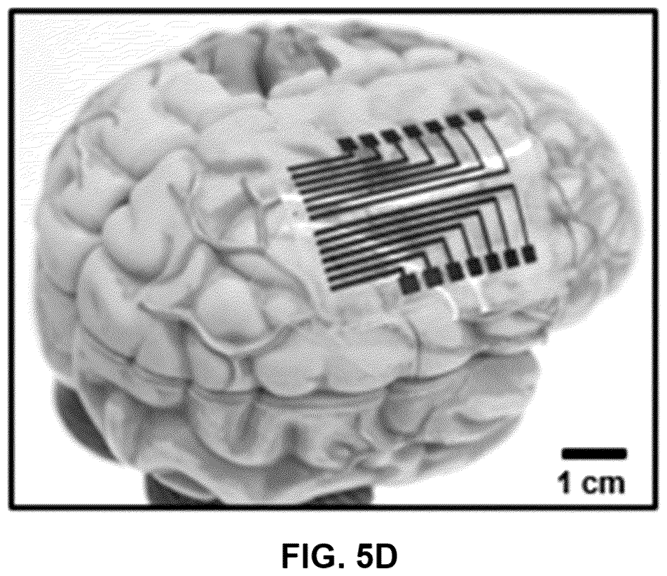

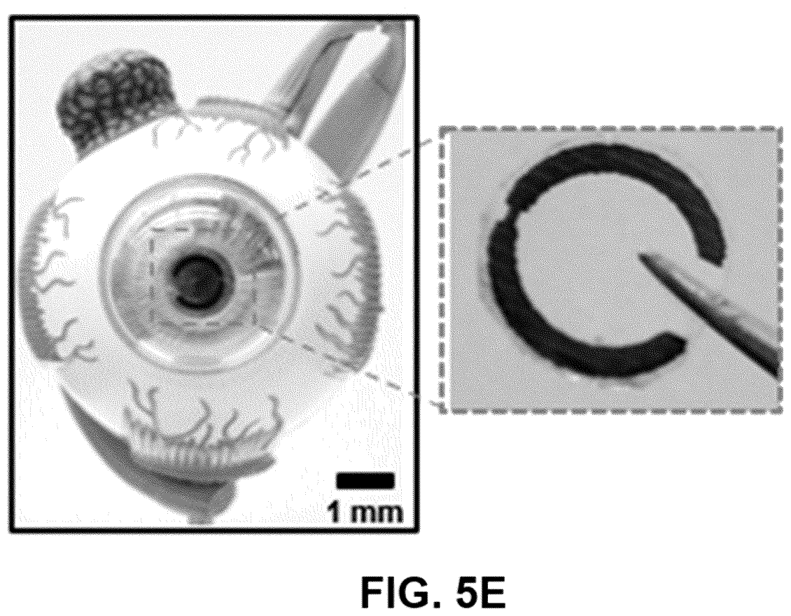

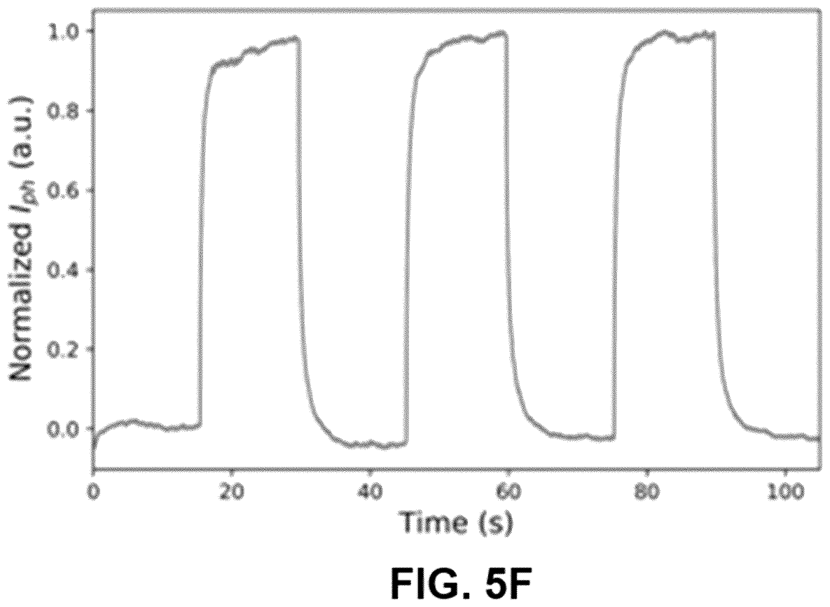

To demonstrate the effectiveness of the fPI-3DPG and the laser-based manufacturing technique, an fPI-3DPG PD array was fabricated with nine photoconductive channels, eighteen interconnects, and contact electrodes by direct photothermal laser engraving on the fPI thin-film substrate (FIG. 5A). The photoresponse of the fPI-3DPG array devices was characterized and evaluated for all nine channels. The fPI-3DPG PD array devices showed a rise time of ˜1 s and a responsivity of up to 0.06 mA W⁻¹. All nine devices exhibited a highly consistent photoresponse to the cyclic on-off light (˜15 s) over seven cycles at λ_{light}=448 nm and Pᵢₙ=5 mW (FIG. 5B).

To determine the capability of spatial measurements of diffused light intensity, the spatial beam profiles were acquired of an incident laser using the PD array devices. The responsivity of individual devices was characterized to determine light intensity distributions of the incident laser beam (FIG. 5C). Based on the calibrated responsivity of individual array devices, the light intensity profile of the incident laser beam was determined. The highest light intensity of 0.65 W cm⁻² was exhibited at the center of the fPI-3DPG photodetector arrays. This shows the capability of the laser-based manufacturing to synthesize functional optoelectronic materials and fabricate photodetector arrays devices with consistent performance by single-step processing. The PD arrays show potential for application to wearable optical imaging and spectroscopy.

The potential of the fPI-3DPG photodetectors was assessed as a highly flexible and conformal photodetector. An fPI-3DPG microelectrode array (MEA) consisting of fourteen electrodes fabricated was fabricated by one-step processing on the fPI film. The fPI-3DPG MEA could be conformably integrated on the surface of the human brain model, showing potential for next-generation electroencephalography (EEG) (FIG. 5D). The transparency of the MEA substrate is advantageous for simultaneous optical neural stimulation, together with the EEG measurements.

Subsequently, another potential of the fPI-3DPG photodetector and laser-based manufacturing approach was investigated by integrating the fPI-3DPG PD on a contact lens of a transparent polyimide thin film with a curved surface (FIG. 5E). The transparency of the fPI thin-film substrate facilitates visibility for contact lens applications. The dynamic photoresponse of the fPI-3DPG photodetector integrated on a contact lens generated a constant photocurrent with a high SNR of ˜217 in response to the cyclic on-off light (FIG. 5F). These demonstrations show the potential of the transparent fPI-3DPG photodetector for a wide range of applications in epidermal electronics and wearable optical sensors, owing to its high flexibility and sensitivity.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

What is claimed is:

1. Three-dimensional, porous graphene having following pore structure:
a) macropores having an average pore size exceeding 50 nm;
b) mesopores having an average pore size of 2-50 nm;
c) micropores having an average pore size of 2 nm or less; and
d) nanopores having an average pore size of less than 100 nm;
wherein the nanopores have a BET specific surface area of at least 300 m²/g.

2. The porous graphene of claim 1, wherein the nanopores have a BET specific surface area of 300-1500 m²/g.

3. The porous graphene of claim 1, which exhibits a Horvath-Kawazoe pore volume of at least 0.2 cm³/g.

4. The porous graphene of claim 1, which exhibits a Horvath-Kawazoe pore volume of 0.2-0.8 cm³/g.

5. The porous graphene of claim 1, which has a mean graphene interlayer spacing of 0.35-0.45 nm.

6. The porous graphene of claim 1, which is prepared by graphitizing a film of a fluorinated polyimide which has at least one aromatic ring.

7. The porous graphene of claim 6, wherein graphitizing comprises irradiating the film with an infrared laser.

8. The porous graphene of claim 6, wherein the fluorinated polyimide has one of the following repeating units: 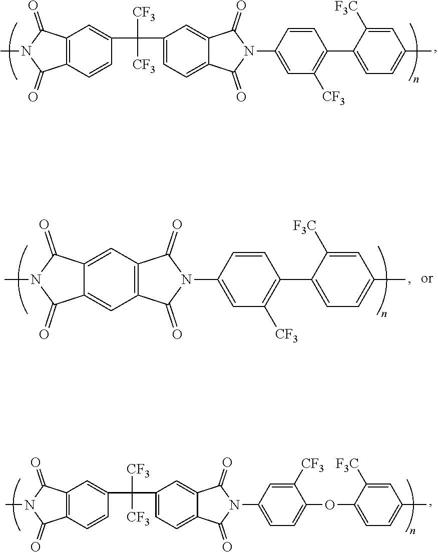
where each instance of n is independently an integer that is at least two.

9. The porous graphene of claim 6, wherein the film of the fluorinated polyimide is prepared by thermal imidization of a precursor polyamic acid film.

10. The porous graphene of claim 6, wherein the film of the fluorinated polyimide has an average thickness of 20-300 μm.

11. A photodetector comprising the porous graphene of claim 1.

12. The photodetector of claim 11, which is part of a device that is configured to be worn by or implanted into a subject.

13. A method for making a porous graphene film, comprising irradiating a film of a fluorinated polyimide which has at least one aromatic ring with an infrared laser under conditions sufficient to form the porous graphene film.

14. The method of claim 13, wherein the fluorinated polyimide has one of the following repeating units: 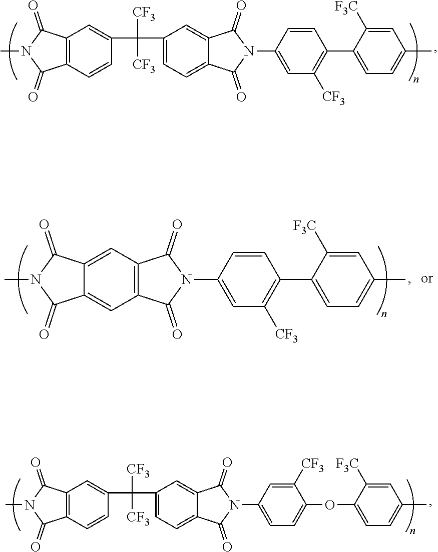
where each instance of n is independently an integer that is at least two.

15. The method of claim 13, wherein the film of the fluorinated polyimide is prepared by thermal imidization of a precursor polyamic acid film.

16. The method of claim 13, wherein the film of the fluorinated polyimide has an average thickness of 20-300 μm.

17. The method of claim 13, wherein the porous graphene film has an average thickness of 10-180 μm.

18. The method of claim 13, wherein irradiating is performed with a CO₂ infrared laser having a wavelength (λ) of 10.6 μm.

19. The method of claim 18, wherein irradiating is performed at 1-2 Watts, 1,000 laser pulses per inch (PPI), and at a speed of 3-4 inches per second.

20. A photodetector comprising the porous graphene film prepared by the method of claim 13.
